(19) United States
(12) Patent Application Publication
(10) Pub. No.: US 2009/0144188 A1
(43) Pub. Date: Jun. 4, 2009

(54) APPARATUS, SYSTEM AND COMPUTER PROGRAM PRODUCT FOR A PAPERLESS CREDIT APPLICATION PROCESS

(75) Inventor: Michael A. Colabucci, Upper Marlboro, MD (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Finance and Compliance Solutions

(21) Appl. No.: 11/947,651

(22) Filed: Nov. 29, 2007

(51) Int. Cl. G06Q 40/00

(52) U.S. Cl. 705/38

(57) ABSTRACT

An apparatus, system and computer program product are provided for a paperless credit application process. Using the apparatus, system and computer program product a customer may enter a dealership, complete a credit application, obtain a credit report, provide any necessary supporting documentation, and receive credit allowance determination, without a physical document ever being created. The system may include a Tablet, through which the customer can complete and transmit an electronic credit application, wherein no record of the completed credit application or the information input by the customer remains on the Tablet. A Finance Server may receive the credit application and create an electronic file or “deal jacket” associated with the customer, in which the credit application and any other information associated with the customer may be stored. The Finance Server may then provide a web-based interface for accessing the deal jacket from any physical location via a secure communication channel.

### FIELD

Embodiments of the invention relate, generally, to a paperless credit application process and, in particular, to an electronic device and corresponding system for uploading and analyzing a customer's credit status and/or fitness via a web-based interface.

### BACKGROUND

Many believe that Finance and Insurance (F&I) operations are critical to the success and profitability of an auto dealership. This belief may be based on the fact that the ability to finance transactions increases the number of cars that can be sold and that more profitability may be seen where financing is available and high margin add-on products (e.g., an extended warranty) can be bundled. However, talented F&I managers are often scarce. A need, therefore, exists for a way in which to provide these F&I managers with the information they need to finance a transaction, regardless of their physical location.

At the same time, ever-increasing concerns exist over privacy and security. Regulatory mandates require dealerships to physically secure private consumer identity and credit information. A credit application that is found not to be “physically secure” may cost a dealer in excess of $10,000 per violation. In addition, the misappropriation of consumer identity and/or credit information as a result of the dealer's negligence may result in the dealer being subject to both civil liability and bad publicity. A further need, therefore, exists for a secure and efficient process for capturing and processing consumer credit applications.

### BRIEF SUMMARY

In general, various embodiments of the present invention provide an improvement by, among other things, providing a paperless credit application process and system, wherein a customer can upload his or her credit application, one or more credit reports associated with the customer can be obtained, and an F&I manager, or other finance analyst, can analyze the customer's credit status regardless of his or her physical location, without a physical piece of paper ever having to be generated. In particular, according to one embodiment, when a customer enters a car dealership for the purpose of potentially purchasing a vehicle, he or she may be handed a Tablet (or wireless personal computer (PC)). Using the Tablet, the customer may complete a credit application by handwriting customer information into a number of data fields displayed on the Tablet touchscreen. The Tablet may then upload the completed credit application (e.g., as both an image of the handwritten application and as a translated digitized text file) to a Finance Server. According to one embodiment, once the completed credit application has been uploaded, no trace of the information input by the customer may remain on the Tablet, thus substantially reducing the risk that private consumer identity or credit information will be wrongfully obtained. Upon receipt of the uploaded credit application, the Finance Server of one embodiment may create a “deal jacket” or electronic file associated with the customer and in which the completed credit application may be stored. The Finance Server may further automatically request a credit report associated with the customer (e.g., based on unique customer information extracted from the completed credit application) and, upon receipt, add the credit report to the customer's deal jacket or electronic file. The Finance Server may then provide access to the customer's deal jacket or electronic file via a web-based interface. Using the web-based interface, an F&I manager, or other finance analyst, may access the customer's information in order to determine the customer's credit allowance, if any, regardless of the physical location of the finance analyst.

According to one aspect an apparatus for providing a paperless credit process is provided. In one embodiment, the apparatus may include a processor that is configured to: (1) receive one or more items of information in the form of handwritten text, wherein the items of information form a completed credit application; (2) create an image of the completed credit application including the one or more items of information in the form of handwritten text; (3) translate the completed credit application into a digitized text file; and (4) transmit the image and the digitized text file, wherein once the image and the digitized text file have been transmitted, no record of the items of information remains on the apparatus.

According to another aspect an apparatus for providing a paperless credit process is provided. In one embodiment the apparatus may include a process that is configured to: (1) receive an image of a completed credit application associated with a customer, wherein the image includes one or more items of information in the form of handwritten text; (2) receive a digitized text file of the completed credit application; (3) store the image and digitized text file in an electronic file associated with the customer; (4) extract from the digitized text file a unique customer identifier associated with the customer; and (5) transmit a request for a credit report associated with the customer, wherein the request includes the extracted unique customer identifier.

In accordance with yet aspect a system for providing a paperless credit process is provided. In one embodiment, the system may include a tablet personal computer and a finance server. The tablet personal computer may be configured to: (1) receive one or more items of information in the form of handwritten text, wherein the items of information form a completed credit application associated with a customer; (2) create an image of the completed credit application including the one or more items of information in the form of handwritten text; (3) translate the completed credit application into a digitized text file; and (4) transmit the image and the digitized text file, wherein once the image and the digitized text file have been transmitted, no record of the items of information remains on the tablet personal computer. The finance server may, in turn, be configured to: (1) receive the image and the digitized text file from the tablet personal computer over a wireless network; (2) create an electronic file associated with the customer, wherein the electronic file stores the image and digitized text file received; and (3) provide access to the electronic file via a web-based interface.

According to one aspect a computer program product for providing a paperless credit process is provided. The computer program product may comprise at least one computer-readable storage medium having computer-readable program code portions stored therein. In one embodiment, the computer-readable program code portions may include: (1) a first executable portion for receiving one or more items of information in the form of handwritten text, wherein the items of information form a completed credit application; (2) a second executable portion for creating an image of the completed credit application including the one or more items of information in the form of handwritten text; (3) a third executable portion for translating the completed credit application into a digitized text file; and (4) a fourth executable portion for transmitting the image and the digitized text file, wherein once the image and the digitized text file have been transmitted, no record of the items of information remains on the apparatus.

According to one aspect a computer program product for providing a paperless credit process is provided. The computer program product may comprise at least one computer-readable storage medium having computer-readable program code portions stored therein. In one embodiment, the computer-readable program code portions may include: (1) a first executable portion for receiving an image of a completed credit application associated with a customer, wherein the image includes one or more items of information in the form of handwritten text; (2) a second executable portion for receiving a digitized text file of the completed credit application; (3) a third executable portion for storing the image and digitized text file in an electronic file associated with the customer; (4) a fourth executable portion for extracting from the digitized text file a unique customer identifier associated with the customer; and (5) a fifth executable portion for transmitting a request for a credit report associated with the customer, wherein the request includes the extracted unique customer identifier.

In accordance with yet another aspect a system for providing a paperless credit process is provided. In one embodiment, the system may include a computer and a finance server. The computer may be configured to: (1) receive one or more items of information forming a completed credit application associated with a customer; (2) receive an image providing authentication that the completed credit application is associated with the customer; (3) translate the one or more items of information into a digitized text file; and (3) transmit the image and the digitized text file, wherein once the image and the digitized text file have been transmitted, no record of the items of information remains on the computer. The finance server may, in turn, be configured to: (1) receive the image and the digitized text file from the computer over a wireless network; (2) create an electronic file associated with the customer, wherein the electronic file stores the image and digitized text file received; and (3) provide access to the electronic file via a web-based interface.

### BRIEF DESCRIPTION OF THE SEVERAL VIEWS OF THE DRAWING(S)

Having thus described embodiments of the invention in general terms, reference will now be made to the accompanying drawings, which are not necessarily drawn to scale, and wherein:

FIG. 1 is a block diagram of one type of system that would benefit from embodiments of the present invention;

FIG. 2 is a schematic block diagram of an entity capable of operating as a Tablet and/or Finance Server in accordance with embodiments of the present invention;

FIGS. 3 and 4 are flow charts illustrating the paperless credit application process of embodiments of the present invention; and

FIGS. 5 through 17E are screen shots of a web-based interface provided by embodiments of the present invention.

### DETAILED DESCRIPTION

Embodiments of the present invention now will be described more fully hereinafter with reference to the accompanying drawings, in which some, but not all embodiments of the inventions are shown. Indeed, embodiments of the invention may be embodied in many different forms and should not be construed as limited to the embodiments set forth herein; rather, these embodiments are provided so that this disclosure will satisfy applicable legal requirements. Like numbers refer to like elements throughout.

### Overview:

In general, embodiments of the present invention provide an apparatus, system and computer program product for a paperless credit application process. The foregoing description describes various embodiments of the present invention in the context of an auto dealership and an associated credit application process for illustration purposes; however, as will be apparent to one of ordinary skill in the art, the present invention is not limited to such applications. Indeed, various embodiments of the present invention may be implemented in any location where confidential user (e.g., customer, client, patient, etc.) information is obtained, stored, and evaluated for purposes of determining whether the user is fit for a particular transaction. For example, the inventive concepts herein described could be implemented in retail stores, banking centers, doctors and/or lawyers offices, mortgage centers, residential housing centers (e.g., apartment leasing offices, etc.), auction houses, investment centers, and the like.

In one embodiment of the present invention, a customer may be able to enter an auto dealership, complete a credit application, obtain a credit report, provide any necessary supporting documentation (e.g., copy of driver's license, proof of residence, proof of employment, etc.), and receive a determination of his or her credit allowance, without a physical document ever needing to be created. In particular, embodiments of the present invention provide a Tablet, or wireless personal computer (PC), which can be used to input and upload the customer's completed credit application directly to a Finance Server (e.g., via a wireless network), thus eliminating the risk of non-physically secured copies of the customer's completed credit application being found. The Finance Server of one embodiment may receive the completed credit application, as well as scanned images of various supporting documents or items associated with the customer, retrieve the customer's credit report, and then provide access to all of this information via a secure web-based interface. As described herein, the web-based interface enables a finance analyst, regardless of his or her physical location, to analyze the customer and his or her credit information in order to approve/reject and/or select financing for the purchase of a vehicle.

As described herein, embodiments of the present invention may assist in safeguarding consumer information, preventing identity theft, strengthening a dealership's compliance programs, protecting against potential losses from fines and lawsuits, and preserving a dealership's brand integrity. Embodiments may further streamline a dealership's credit processing, centralize F&I operations, and reduce the amount of time required to approve and fund a deal or sale. In addition, according to embodiments of the present invention, real-time tracking and reporting of Ups Logs, completed credit applications and funded deals may be provided, with instant deal retrieval, whether current or past.

### Overall System, Tablet and Finance Server:

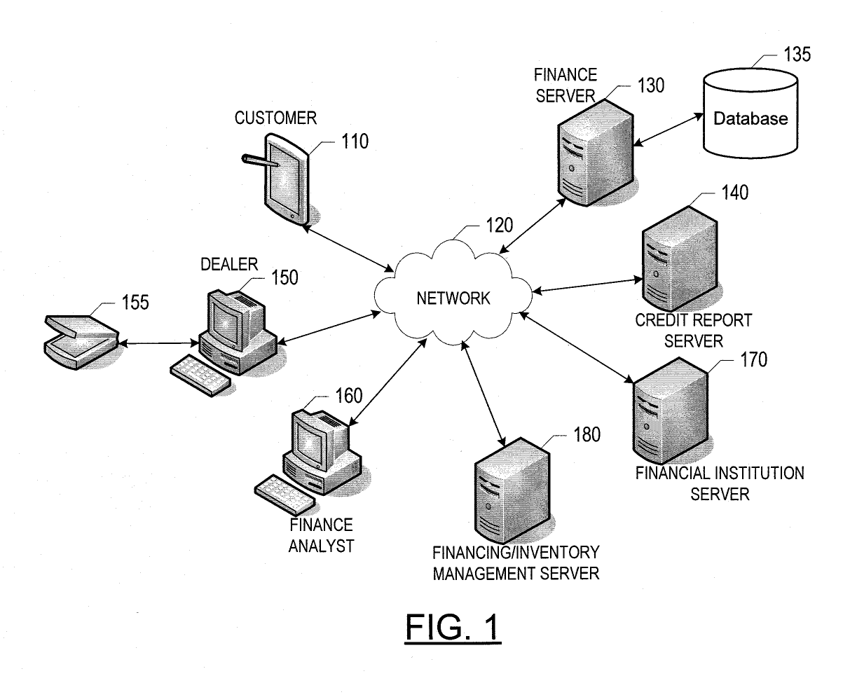

Referring to FIG. 1, an illustration of one type of system that would benefit from embodiments of the present invention is provided. As shown, the system may include a Tablet 110, or wireless personal computer (PC) configured to allow a user to input data using natural language via a stylus, pen, pencil or other pointing device, on a touch-sensitive input device or touchscreen. In one embodiment, a customer may use the Tablet 110 to complete an electronic credit application in association with the purchase of a vehicle from a dealership with which the Tablet 110 is associated. The system may further include a Finance Server, or similar network entity, 130 configured to receive the completed credit application and, in particular, an image of the handwritten completed credit application as well as a translation of the handwritten completed credit application into a digitized text file, from the Tablet 110 via a communication network 120. The communication network 120 may, for example, comprise a wireless local area network (WLAN), wireless wide area network (WWAN), wireless metropolitan area network (WMAN), a wireless personal area network (WPAN), or the like. In one embodiment, the Tablet 110 may be configured to only be capable of communicating with the Finance Server 130 over the wireless communication network 120 when the Tablet 110 is within proximity of the dealership with which it is associated (referred to as “communication proximity”). This may be done by, for example, storing a unique uniform resource locator (URL) to be used for accessing the Finance Server 130 in a configuration file of the Tablet 110). The Finance Server 130 may further be in communication with a database 135, in which the Finance Server 130 may save the completed credit application received from the Tablet 110 in the form of a “deal jacket” or electronic file associated with the customer.

According to one embodiment, the system may further include a Credit Report Server, or similar network entity, 140 also in communication with the Finance Server 130 over the same or different wired or wireless communication network 120. As discussed in more detail below, the Finance Server 130 of one embodiment may be configured to transmit a request for a credit report associated with the customer to the Credit Report Server 140. The Credit Report Server 140 may, in turn, be configured to receive the request and transmit the credit report to the Finance Server 130, which may save the credit report received in the database 135 in association with the customer (i.e., in the deal jacket or electronic file associated with the customer).

The system of one embodiment may further include an electronic device (e.g., personal computer (PC), laptop, personal digital assistant (PDA), etc.) 150 associated with a dealer at the dealership from which the customer is looking to purchase a vehicle, as well as a scanning device 155 in communication with the dealer electronic device 150. As discussed in more detail below, according to one embodiment, a dealer, salesperson, or other individual, may use the scanning device 155 to scan items or documents associated with the customer (e.g., driver's license, proof of employment, etc.), such that the scanned images may be transmitted to the Finance Server 130 via the dealer electronic device 150 and a wired or wireless communication network 120. Upon receipt of the scanned images, the Finance Server 130 may store the images in the deal jacket or electronic file associated with the customer in the database 135.

According to one embodiment, the system may further include an electronic device (e.g., PC, laptop, PDA, etc.) 160 operated by a finance analyst (e.g., F&I manager) for the purpose of reviewing and evaluating a customer's credit status and overall fitness for a particular transaction and/or financing product (hereinafter referred to as “a customer's credit status and/or fitness”). The finance analyst electronic device 160 may be located remotely from or in proximity to the dealer electronic device 150 (e.g., within the same store or dealership, or at a completely separate location). As discussed in more detail below, according to one embodiment of the present invention, after receiving the completed credit application, credit report, and any scanned items or objects associated with the customer, and storing these items in a deal jacket or electronic file associated with the customer, the Finance Server 130 may provide access to the deal jacket or electronic file via a web-based interface. The finance analyst electronic device 160 may access the web-based interface via a wired or wireless communication network 120 in order to access the information associated with the customer and assess the customer's credit status and/or fitness. The system of one embodiment may further include a Financial Institution Server 170 and a Financing/Inventory Management Server 180 also in communication with the Finance Server 130 over the same or different communication network 120 for the purpose of aiding in finalizing the financial and purchasing transaction with the customer.

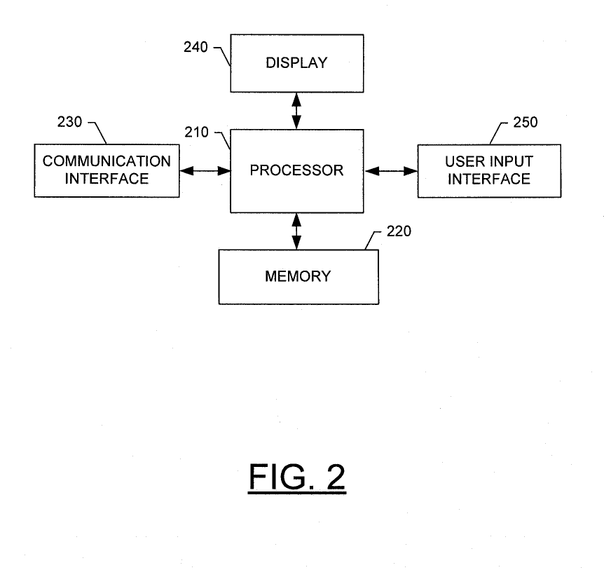

Referring now to FIG. 2, a block diagram of an entity capable of operating as either the Tablet 110 or the Finance Server, or similar network entity, 130 is shown in accordance with one embodiment of the present invention. The entity capable of operating as the Tablet 110 or the Finance Server 130 includes various means for performing one or more functions in accordance with embodiments of the present invention, including those more particularly shown and described herein. It should be understood, however, that one or more of the entities may include alternative means for performing one or more like functions, without departing from the spirit and scope of the present invention. As shown, the entity capable of operating as the Tablet 110 or the Finance Server 130 can generally include means, such as a processor 210 for performing or controlling the various functions of the entity.

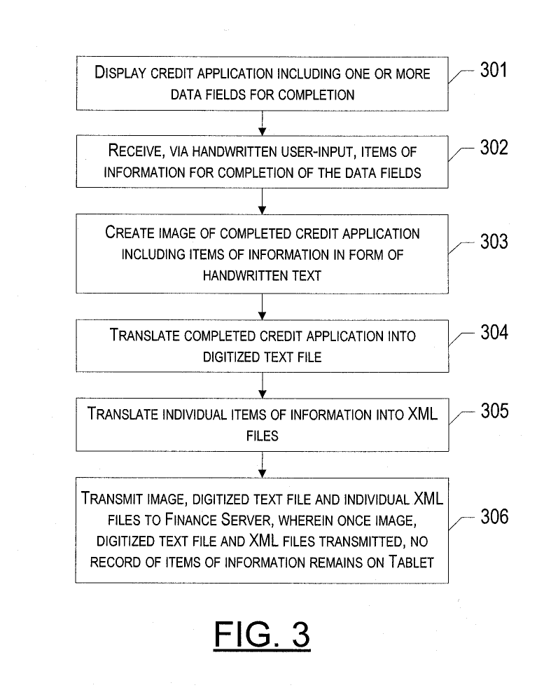

In particular, as is discussed in more detail below with regard to FIG. 3, in one embodiment wherein the entity is configured as a Tablet 110, the processor 210 may be configured to receive one or more items of information in the form of handwritten text, wherein the items of information form a completed credit application. The processor 210 may further be configured to create an image (e.g., a portable document format (PDF) image) or a series of images representing the completed application and including the items of information in the form of handwritten text. The processor 210 may further translate the completed credit application into a digitized text file, for example, using optical character recognition or other techniques apparent to one of skill in the art. The processor 210 may then be configured to transmit the image(s) and the digitized text file, for example, to the Finance Server 130, wherein once the image(s) and the digitized text file have been transmitted, no record of the items of information remains on the Tablet 110.

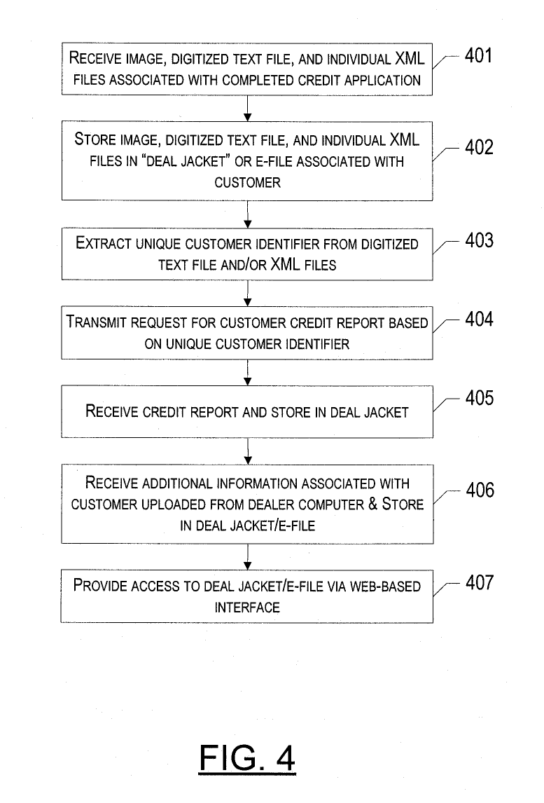

According to another embodiment, discussed in more detail below with regard to FIG. 4, wherein the entity is configured as a Finance Server 130, the processor 210 may further be configured to receive, for example from the Tablet 110, an image (e.g., PDF image) or series of images of a completed credit application associated with the customer, wherein the image(s) include one or more items of information in the form of handwritten text, as well as a digitized text file of the completed credit application. The processor 210 may be further configured to store the image(s) and digitized text file in an electronic file associated with the customer (e.g., in the database 135). In one embodiment, the processor 210 of the Finance Server 130 may further be configured to extract from the digitized text file a unique customer identifier (e.g., a social security number) associated with the customer, and to transmit (e.g., to the Credit Report Server 140) a request for a credit report associated with the customer, wherein the request includes the extracted unique customer identifier.

In one embodiment, the processor is in communication with or includes memory 220, such as volatile and/or non-volatile memory that stores content, data or the like. For example, the memory 220 typically stores content transmitted from, and/or received by, the entity. Also for example, the memory 220 typically stores software applications, instructions or the like for the processor to perform steps associated with operation of the entity in accordance with embodiments of the present invention. In particular, the memory 210 may store computer program code, instructions or the like for the processor to perform the steps described above and below with regard to FIGS. 3 and 4, respectively, depending upon whether the entity is configured as the Tablet 110 or the Finance Server 130.

In addition to the memory 220, the processor 210 can also be connected to at least one interface or other means for displaying, transmitting and/or receiving data, content or the like. In this regard, the interface(s) can include at least one communication interface 230 or other means for transmitting and/or receiving data, content or the like, as well as at least one user interface that can include a display 240 and/or a user input interface 250. The user input interface, in turn, can comprise any of a number of devices allowing the entity to receive data from a user, such as a keypad, a touch display, a joystick or other input device. In particular, as briefly mentioned above with regard to FIG. 1, in an embodiment wherein the entity is configured as a Tablet 110, the user input device may comprise a touch sensitive input device or touchscreen.

As one of ordinary skill in the art will recognize, the touchscreen may comprise two layers that are held apart by spacers and have an electrical current running therebetween. When a user (e.g., a customer) touches the touchscreen, the two layers may make contact causing a change in the electrical current at the point of contact. The Tablet 110 may note the change of the electrical current, as well as the coordinates of the point of contact in order to detect the handwritten customer input to the device. Alternatively, wherein the touchscreen uses a capacitive, as opposed to a resistive, system to detect tactile input, the touchscreen may comprise a layer storing electrical charge. When a user (e.g., customer) touches the touchscreen, some of the charge from that layer is transferred to the user causing the charge on the capacitive layer to decrease. Circuits may be located at each corner of the touchscreen that measure the decrease in charge, such that the exact location of the tactile input can be calculated based on the relative differences in charge measured at each corner. Embodiments of the present invention can employ other types of touchscreens, such as a touchscreen that is configured to enable touch recognition by any of resistive, capacitive, infrared, strain gauge, surface wave, optical imaging, dispersive signal technology, acoustic pulse recognition or other techniques, and to then provide signals indicative of the location of the touch.

The touchscreen interface of the Tablet 110 may be configured to receive an indication of an input in the form of a touch event at the touch screen display. The touch event may be defined as an actual physical contact between a selection object (e.g., a finger, stylus, pen, pencil, or other pointing device) and the touchscreen display. Alternatively, a touch event may be defined as bringing the selection object in proximity to the touchscreen display (e.g., hovering over an object or approaching an object within a predefined distance).

### Method of Providing a Paperless Credit Application Process

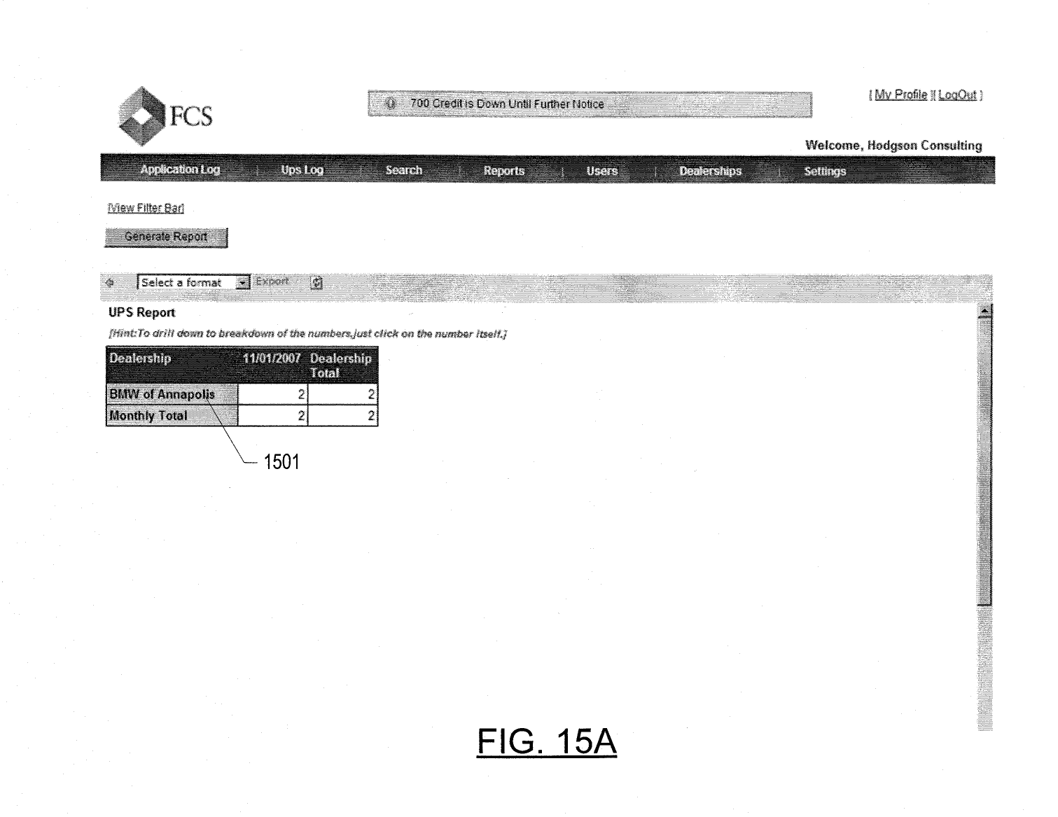

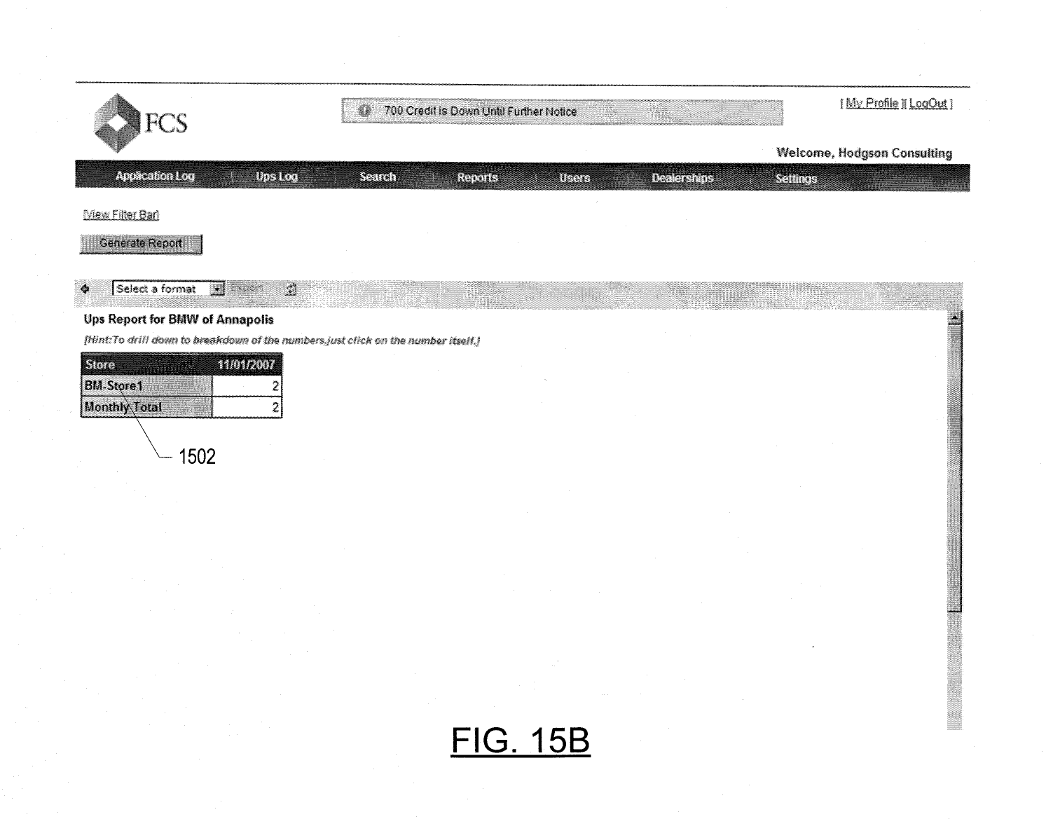

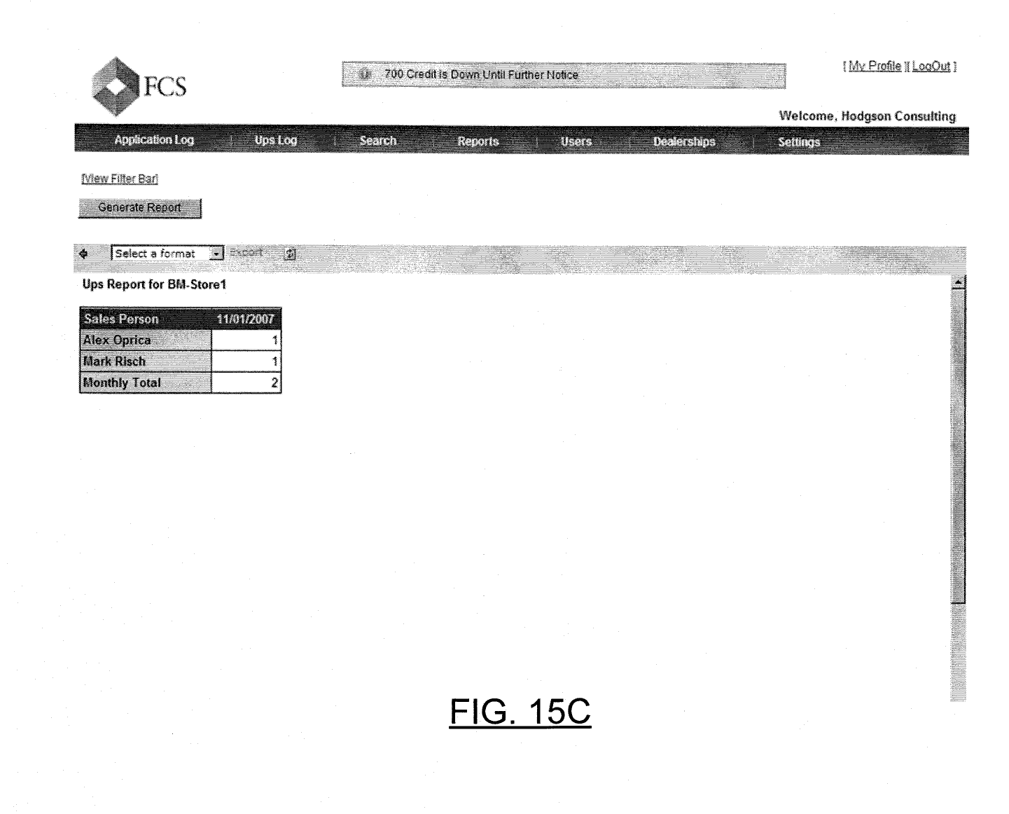

Referring now to FIGS. 3 and 4, the operations are illustrated that may be taken in order to provide the paperless credit application process of embodiments of the present invention. While not specifically shown, the process may begin when a customer enters a dealership, store, etc., for the purpose of investigating the purchase of a vehicle or other transaction. Upon entering, the customer may be given a Tablet 110 and instructed to complete an “Ups Log” via the Tablet 110. An Ups Log may comprise a short form or personal data sheet that may include, for example, the customer's name, email address, phone number, and the like. Upon completion of the Ups Log, the Tablet 110 may upload the Ups Log to the Finance Server 130 via the communication network 120. In some embodiments, the Tablet 110 is configured to retain no trace in its memory of the completed Ups Log or the customer information entered associated therewith after upload to avoid unauthorized access of such information should the Tablet 110 be stolen or misplaced. Uploading the completed Ups Log to the Finance Server 130 may be done in order to initially place the customer in the overall system in accordance with various embodiments of the present invention. In addition, as described in more detail below with regard to FIGS. 15A-C, the Ups Logs may be used by a dealer, or other individual, to keep track of the number of customers who entered the dealership, and to compare that figure to, for example, the number of customers who completed a credit application (e.g., in the manner described below) and/or the number of customers who ultimately purchased a vehicle, obtained financing, or otherwise completed a transaction with the dealership.

When and if the customer decides that he or she is interested in purchasing a vehicle (or would just like to know what type of financing he or she could obtain), the customer may again be given a Tablet 110 (alternatively, the customer may have remained in possession of the Tablet 110 after completing and uploading the Ups Log), on which a credit application may be displayed. In some embodiments, a customer may know immediately that they wish to submit a credit application and in such circumstances the completion of an Ups Log may be omitted. In such embodiments, the completion of the credit application may serve as the basis for creating the deal jacket as will be apparent to one of ordinary skill in the art.

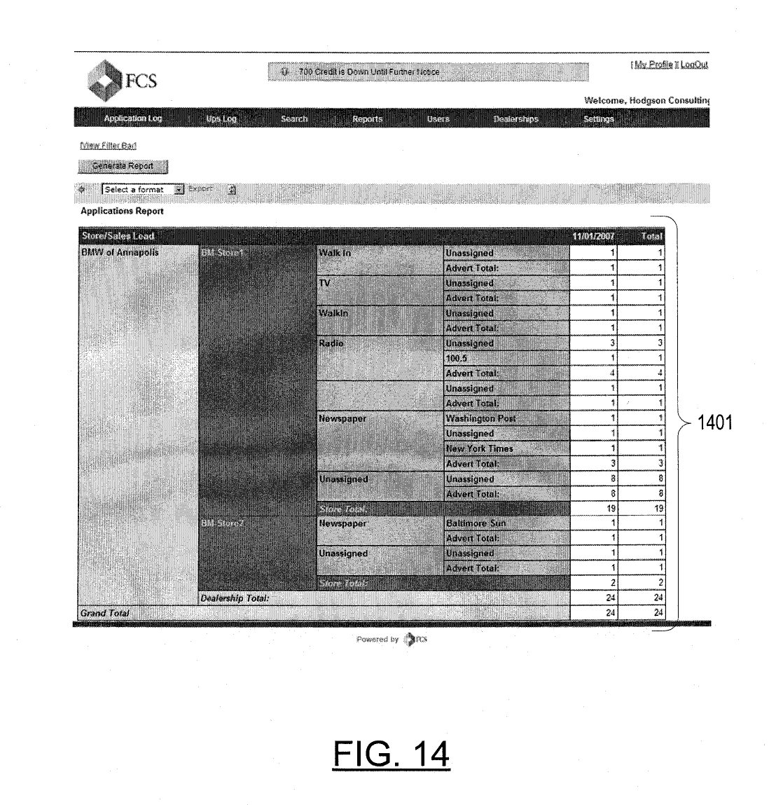

In various embodiments, the credit application displayed to a customer via the Tablet 110 may be specifically tailored for a given dealership or a generic credit application that is usable by a variety of dealerships or other enterprises. Customization data including credit application profiles or other data that is readable by the Tablet 110 or its processor for creating a specific or generic credit application may be stored in the memory of the Tablet 110 or downloaded to the Tablet 110 from a remote location. Other customizable features (such as advertising information, discussed below with regard to FIG. 14) may be provided for the Tablet 110 in this manner as will be apparent to one of skill in the art.

The credit application presented via the Tablet 110 may include a number of data fields for the customer to complete by providing a corresponding number of items of information (Block 301). These items of information may include, for example, the customer's name, address, phone number, occupation, social security number, and the like. The customer may complete the application by using a stylus, pen, pencil, or other pointing device, to handwrite the items of information into the blank data fields of the credit application displayed on the touchscreen of the Tablet 110. The Tablet 110, and in particular a processor 210 or similar means operating on the Tablet 110, may, at Block 302, receive the handwritten user-input items of information. In particular, the processor 210, or similar means, may be configured to detect the tactile input associated with the handwritten items of information via any of the known methods described above with regard to FIG. 2.

The Tablet 110 (e.g., the processor 210 or similar means operating on the Tablet 110) may then create, at Block 303, an image (e.g., a portable document format (PDF) image) or series of images of the completed credit application including the handwritten items of information. In addition, the processor 210, or similar means, may, at Blocks 304 and 305, respectively, translate the completed credit application into a digitized text format and translate one or more of the handwritten items of information into individual extensible markup language (XML) files including the raw data conveyed by the corresponding item of information. In one embodiment, the translations may be preformed using optical character recognition (OCR). As one of ordinary skill in the art will recognize, OCR may involve photoscanning the completed credit application and/or the individual handwritten items of information and analyzing each character of the plurality of characters included in the handwritten items of information. In particular, the scanned image may be analyzed for light and dark areas in order to identify each alphabetic or numeric digit. When a character is recognized, it may be converted into a character code that may be recognized by the processor 210, or similar means (e.g., an American Standard Code for Information Interchange (ASCII) code).

In yet another embodiment, optical character recognition or other similar techniques may not be necessary. For example, a customer may complete a credit application on a Tablet 110, PC, laptop, or the like, using a keyboard, mouse, or other interface such that the application is created in digitized text format and/or XML (i.e., not handwritten). In such circumstances, it may be appropriate for a customer to authenticate the credit application by signing the application using a touchscreen and/or stylus as discussed above. The Tablet 110 or other processor may then create an image of the handwritten signature but, as will apparent to one of skill in the art, such handwritten signature need not undergo optical character recognition. In still other embodiments, a typed or otherwise non-handwritten credit application may be authenticated by capturing an image of a customer's fingerprint, retinal scan, by using other biometric authentication techniques and/or by using any other electronic authentication techniques that may be apparent to one of ordinary skill in the art in view of this disclosure.

Once the image has been created and the completed credit application and individual items of information have been translated, if necessary, the Tablet 110, and in particular the processor 210 or similar means operating on the Tablet 110, may transmit the image, digitized text file and individual XML files to the Finance Server 130 via the communication network 120. According to various embodiments of the present invention, upon transmission, no record of the items of information remains on the Tablet 110. In other words, according to embodiments of the present invention, the items of information received from the customer as well as the completed credit application are never saved directly to the Tablet 110. Instead, the Tablet 110 is configured to communicate this information directly to the Finance Server 130, and no trace of the information remains in the Tablet 110 memory. By never storing customer-input information on the Tablet 110 a dealership, store, or the like, can avoid the risk of potentially private customer-specific information (e.g., the customer's social security number, etc.) being obtained by unauthorized persons. In this regard, the potential for identity theft or fraud can be reduced.

The process now continues on FIG. 4, which generally illustrates the portion of the process performed by the Finance Server 130 after the customer-completed credit application has been uploaded. As shown, the Finance Server 130, and in particular a processor 210, or similar means operating on the Finance Server 130, at Block 401, may receive the image, digitized text file and individual XML files associated with the completed credit application from the Tablet 110. At Block 402, the Finance Server 130 (e.g., the processor or similar means) of one embodiment may store the image, digitized text file, and individual XML files in the database 135 in an electronic file, referred to as a “deal jacket,” associated with the customer. The Finance Server 130 (e.g., the processor or similar means) may then, at Block 403, extract a unique customer identifier, such as the customer's social security number, from either the digitized text file or the individual XML files received from the Tablet 110.

The Finance Server 130 and, in particular, the processor or similar means operating on the Finance Server 130, may use the extracted unique customer identifier to transmit, at Block 404, a request to the Credit Report Server 140 requesting a copy of the credit report associated with the customer. According to one embodiment, the Credit Report Server 140 may be associated with any one of a number of credit agencies including, for example, Equifax®. The Finance Server 130 (e.g. a processor or similar means operating on the Finance Server 130) may transmit the request directly to the Credit Report Server 140 associated with the credit agency. Alternatively, the Finance Server 130 (e.g., processor) may transmit the request to a server, or similar network entity, associated with a vendor configured to act as an intermediary or “middleman” between the Finance Server 130 and the credit agency. In particular, as one of ordinary skill in the art will recognize, many credit agencies require rather arduous certification and auditing procedures in order for a party to pull credit reports directly from the credit agency servers. In order to avoid such arduous procedures, the Finance Server 130 may use a vendor (e.g., First American CREDCO or 700Credit, etc.), which has already gone through the auditing process.

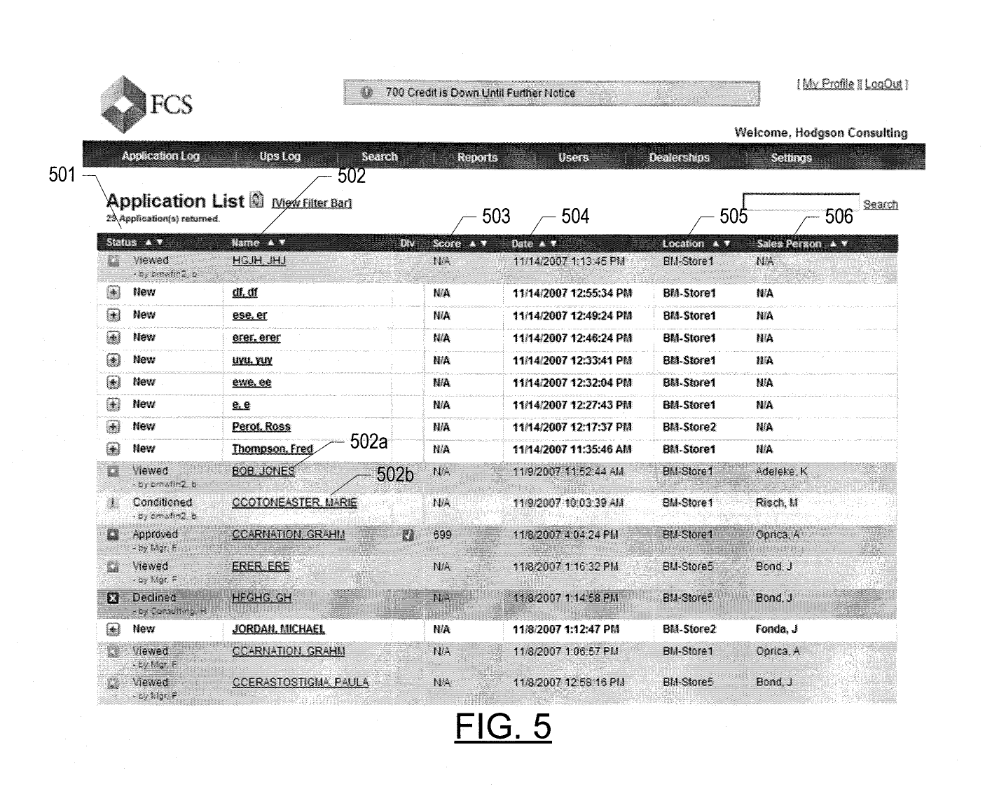

Regardless of whether received directly from the credit agency server or via a middleman, upon receiving the credit report, at Block 405, the Finance Server 130 (e.g., the processor or similar means) may store the credit report in the deal jacket associated with the customer (e.g., in the database 135 linked, for example, to the customer's unique identifier). While not shown, the Finance Server 130 (e.g., processor or similar means) may further extract various pieces of raw data from the credit report for use in the web-based interface described in more detail below with regard to FIGS. 5-17E.

The Finance Server 130 and in particular the processor or similar means operating on the Finance Server 130 may further receive additional information associated with the customer that can be added to the customer's deal jacket. (Block 406). In one embodiment, this information may include scanned images of various items associated with the customer, such as his or her driver's license, proof of employment, proof of residence, vehicle trade-in information (e.g., vehicle identification information, title, registration, information concerning outstanding debt on the trade-in vehicle, etc.) and/or the like. As discussed above, these items may have been scanned using the scanning device 155 in communication with the dealer electronic device 150. Alternatively, in another embodiment, the Tablet 110, itself, may comprise, or be in communication with, a scanning device, such that when the customer is completing his or her credit application using the Tablet 110, he or she may also scan copies of the various items. The Tablet 110 (e.g., a processor or similar means operating on the Tablet 110) may be configured to transmit the scanned images to the Finance Server 130 at the same time or after transmitting the various versions of the completed credit application.

At Block 407, the Finance Server 130 and, in particular, a processor or similar means operating on the Finance Server 130 may provide access to the deal jacket or electronic file established in association with the customer via a web-based interface. As described above with regard to FIG. 1, according to one embodiment, a finance analyst (e.g., F&I manager) may access the electronic file via the web-based interface in order to analyze the customer's credit status and/or fitness. In particular, according to one embodiment of the present invention, a financial analyst, who may or may not be physically located at the dealership from which the customer is considering the purchase of a vehicle, may use his or her electronic device (e.g., PC, laptop, PDA, etc.) 160 to log onto or connect to the web-based interface via a secure communication channel and remain logged on for the duration of the finance analyst's workday. When a new completed credit application has been uploaded along with the corresponding credit report, the web-based interface may make a sound, such as a beep or tone, indicating to the financial analyst that a new customer's information needs to be reviewed. The financial analyst may then use his or her device 160 to access the customer's deal jacket or electronic file including the completed application and credit report, as well as any supporting documents scanned by the dealer, salesperson, or the customer him- or herself. Based on the information reviewed, the financial analyst may determine whether or not the customer is approved for credit and, if so, for how much. In some embodiments, the financial analyst may submit information from the customer's deal jacket or electronic file electronically to one or more financial institutions (e.g., banks and/or the financing/inventory management systems discussed below). Such financial institutions may evaluate such information to determine the customer's fitness for a particular financing product offered by the financial institution (e.g., by comparing the customer's credit information to a plurality of financial products in order to select acceptable products for the customer). As will be apparent to one of ordinary skill in the art, this process is commonly automated via a server or processor operated by the financial institution. An electronic message may be transmitted from the financial institution to the financial analysis indicating whether the customer is approved for credit and, if so, for how much.

The financial analyst may then convey this information to the dealer or salesperson, for example, verbally in person or by phone, via the web-based interface, which the dealer or salesperson may also access, or via any other similar means. The sale or transaction can thereafter be completed based on the financing decision provided by the financial analyst and/or financial institution. The details of the web-based interface and the foregoing process of embodiments of the present invention are discussed in greater detail below with regard to FIGS. 5-17E.

While the foregoing may imply that the Finance Server 130 provides access to the electronic file associated with the customer only after the credit application, credit report, and any supporting documents have been added to the electronic file, as one of ordinary skill in the art will recognize, embodiments of the present invention are not so limited. In contrast, according to one embodiment, a dealer, financial analyst, salesperson, or the like, may access a customer's electronic file at any point in time after at least some portion of the customer's information has entered the system. This may include, for example, immediately after the customer's Ups Log has been uploaded to the Finance Server 130.

While not shown in FIG. 4, according to one embodiment, to facilitate completion of a transaction, the Finance Server 130 (e.g., the processor or similar means operating on the Finance Server 130) may push certain pieces of customer information obtained from the completed credit application, credit report, trade-in information, and/or supporting documents to a financing/inventory management system, such as that provided by DealerTrack®, Route One®, or the like. Prior to doing so, it may be further necessary for the Finance Server 130 (e.g., processor or similar means) to translate the data into a format acceptable by the financing/inventory management system. By automatically pushing this information to the inventory management system, embodiments of the present invention may eliminate a significant amount of double data entry.

As will be apparent to one of skill in the art, financing/inventory management systems may use the information received from the Finance Server 130 to identify appropriate financing products to support a transaction, to prepare closing documents to support the transaction, to manage a dealership's inventory following a transaction, to identify a value for a trade-in vehicle proposed as part of a transaction, to identify possible buyers for any trade-in vehicle accepted as part of a transaction, to identify secondary markets for any commercial paper generated by the transaction. For example, the financing/inventory management system may use customer credit information received from the Finance Server 130, along with dealership inventory information known to provide a suggestion of the most profitable vehicles on the dealer's lot to recommend to the customer based on his or her credit status. In addition, the financing/inventory management system may use trade-in vehicle information received from the Finance Server 130 to generate and provide a comparison of N.A.D.A®, Black Book® and Kelley Blue Book® values associated with the trade-in vehicle. As yet another example, the financing/inventory management system may use all of the information received from the Finance Server 130 in association with a number of potential customers to generate and provide various reports, such as financing reports that summarize the credit applications received by type, term, amount and/or income, lender activity reports that summarize credit applications received by financing source, or the like.

### Web-Based Interface for Accessing Paperless Credit Application Process

The following provides a description of a web-based interface through which a customer's deal jacket, or electronic file including customer credit information (e.g., credit application, credit report, supporting documents, etc.), can be accessed in order to assess the customer's potential credit status and/or fitness for a particular transaction. The following is provided for exemplary purposes only and should not be taken as limiting embodiments of the invention in any way to the specific implementation described. In contrast, as one of ordinary skill in the art will recognize, other similar interfaces may likewise be provided without departing form the spirit and scope of embodiments of the invention and, therefore, should be considered within the scope of embodiments of the present invention.

Referring now to FIG. 5, an example of an Application Log provided by one embodiment of the web-based interface is illustrated. As shown, the Application Log may provide a list of all of the credit applications that have been uploaded to the Finance Server 130 within a certain period of time. The list may include the status of the credit application 501 (e.g., New, Viewed, Conditioned, Approved, Declined, etc.), customer name 502, credit score calculated 503, date uploaded 504, store from which uploaded 505, and salesperson responsible for receiving 506. According to one embodiment, this list may be automatically updated in real time as new completed credit applications are uploaded. As discussed above, in one embodiment, as each new completed credit application is uploaded, a sound (e.g., a beep or tone) may be generated indicating, for example, to the financial analyst that a new customer's information has been received and needs to be reviewed. In one embodiment, the credit applications displayed by this screen to a user logged onto the web-based interface may depend upon the status of the particular user. For example, if the user logged onto the web-based interface is associated with a particular dealership, his or her view may display all completed credit applications received in association with that dealership. Alternatively, where the user is associated with a particular store within the dealership, his or her view may display only the completed credit applications received in association with that store.

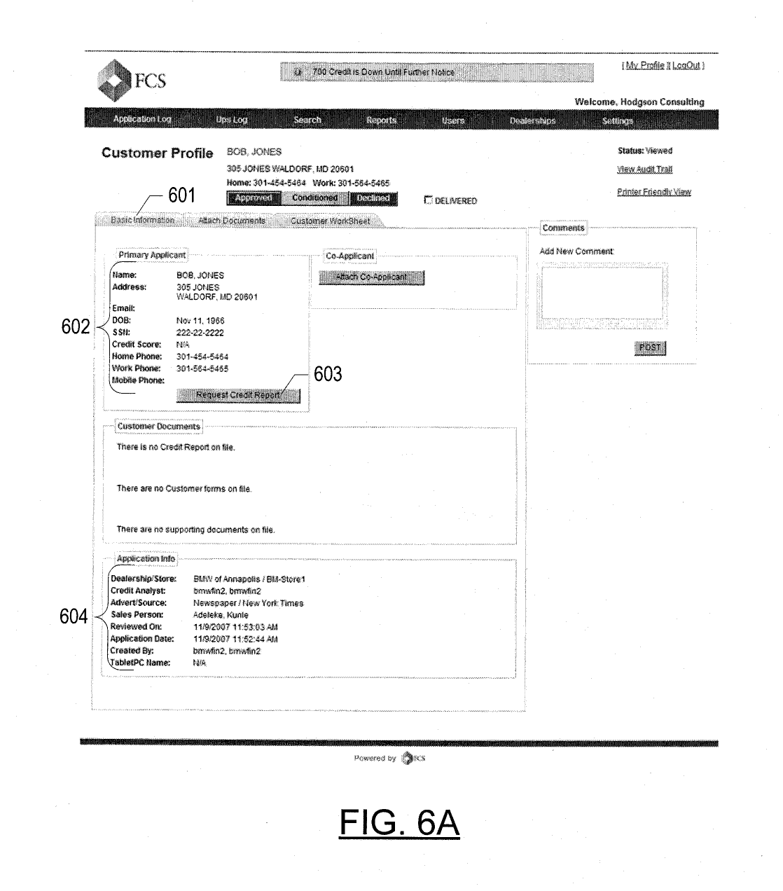

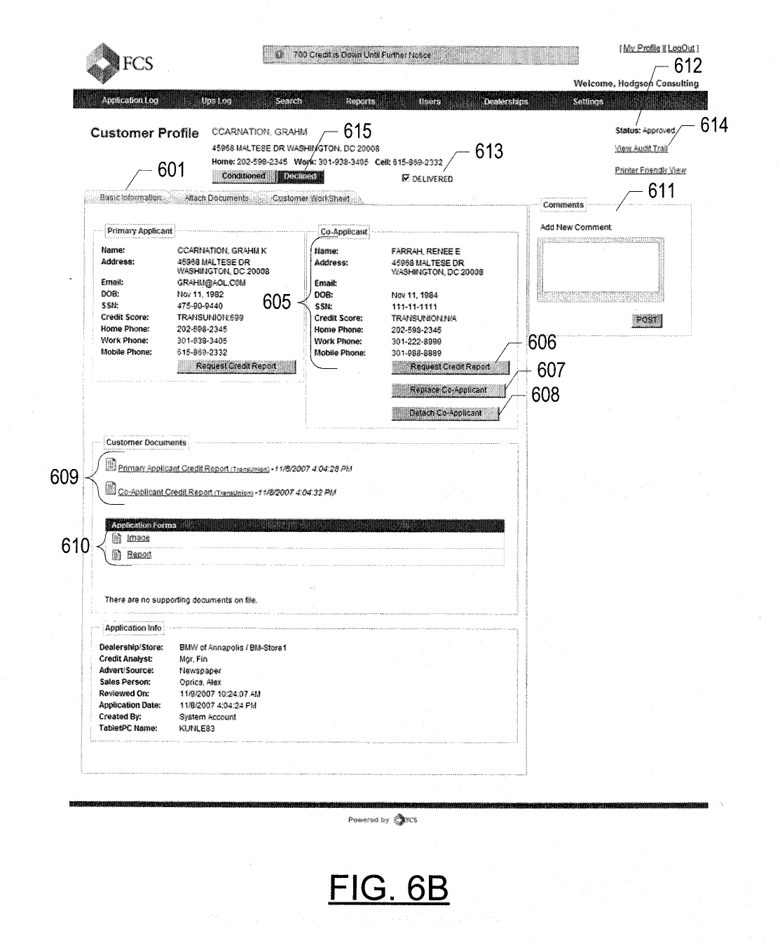

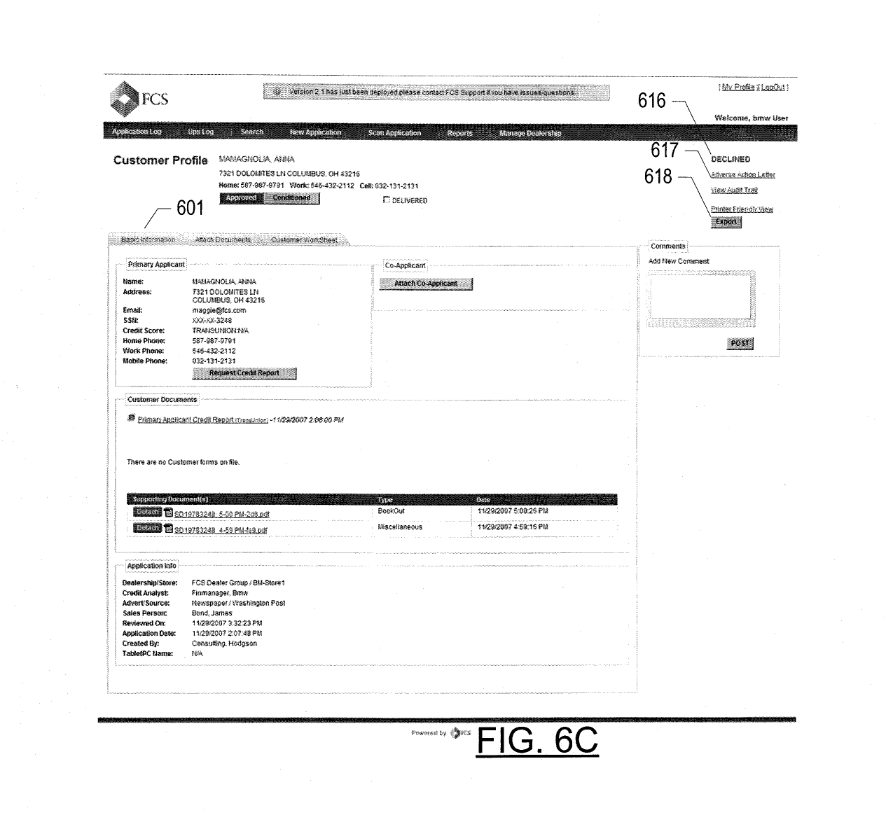

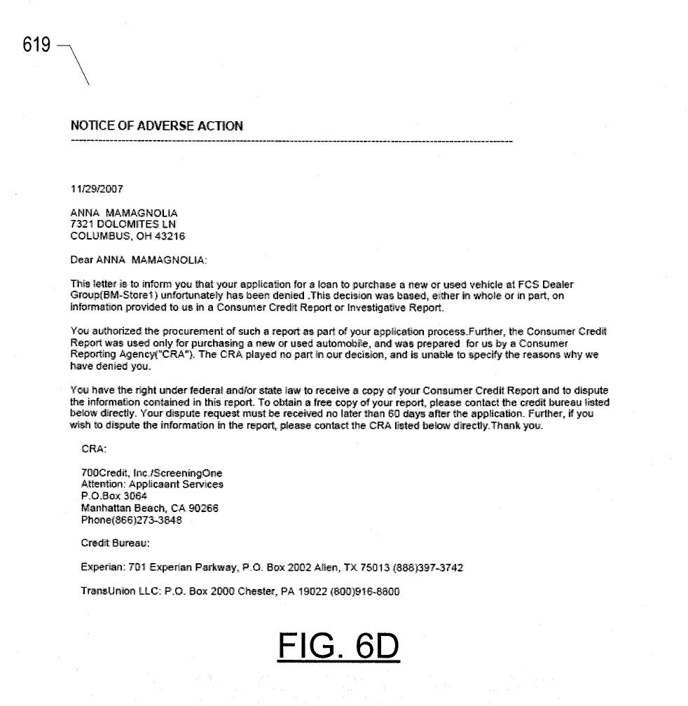

In order to access the deal jacket or electronic file associated with a customer from whom a completed credit application has been received, the user can select by, for example, clicking on or otherwise actuating, the displayed name of the customer 502a, 502b. FIGS. 6A and 6B illustrate the deal jackets that may be displayed upon selecting the names of customers BOB JONES 502a and CCONTONEASTER, MARIE 502b, respectively. Referring to FIG. 6A, the first screen displayed may correspond to the Basic Information tab 601 of the deal jacket. This screen may provide basic information about the customer 602 that has been, for example, extracted from either the digitized text file associated with the completed credit application received from the Tablet 110, or the individual XML files corresponding to the items of information received from the customer. This information may include, for example, name, residence, phone number, and date of birth information associated with the customer, as well as the customer's social security number and email address. While as described above, the Finance Server 130 may automatically request the credit report associated with a customer upon receiving the completed credit application, in some instances the credit score obtained in the original credit report may be insufficient for the customer to obtain the amount of credit he or she desires. In this instance, or for any other reason, a user accessing the customer's deal jacket may manually request another credit report using a tab selectable 603 displayed on the Basic Information tab 601 of the customer's deal jacket.

As shown, the Basic Information screen of the customer's deal jacket may further include application information 604, which may have also been extracted by the Finance Server 130 from either the digitized text file or the XML files received. This information may include, for example, the name of the dealership and store, credit analyst, and salesperson; the advertisement source, or how the customer heard about the dealership or store; the application date and the date it was reviewed; and the unique name given to the Tablet 110 on which the credit application was completed.

Referring now to FIG. 6B, which provides another example of a Basic Information screen 601 of the customer's deal jacket. As shown, this screen may further include information associated with a co-applicant 605, as well as a selectable tab for requesting a credit report for the co-applicant 606, replacing the co-applicant 607, and detaching the co-applicant 608. This screen may also include links to the credit reports 609 retrieved by the Finance Server 130, as well as the image and digital text file of the completed credit application 610 received from the Tablet 110. A window 611 may also be provided via which a user may post comments associated with the particular customer, his or her credit application, supporting documents, or the like. The comments may be posted, for example, in order to memorialize decisions made and/or to make a note of additional documentation needed. This feature may be particularly useful when the dealer or salesperson is not at the same location as the financial analyst.

The Basic Information screen 601 may further include a means by which certain users can indicate the status of the customer's credit application 612. In particular, according to one embodiment, a drop down menu may be provided wherein if the user is a financial analyst, he or she may be able to change the status of the credit application by selecting from the drop down menu whether the credit application has been or is, for example, viewed, pending, conditioned, allowed, or declined. Alternatively, or in addition, the user may be able to select, for example by clicking on or otherwise actuating a selectable button designated Conditioned, Approved, or Declined. Similarly, the user may be able to indicate, for example using a checkbox 613, whether the credit decision has been delivered. According to one embodiment, a link to the audit trail 614 associated with the customer's credit application may also be provided on the Basic Information screen 601. This trail may include, for example, a list of each time a credit report was requested, the customer's record was updated, the status of the deal jacket was changed, the decision regarding the application was delivered, or the like.

As noted above, in order to, for example, decline a customer's credit application, the user may select the selectable button marked “Declined” 615. In response to selecting the Declined button 615, according to one embodiment illustrated in FIG. 6C, the Basic Information screen 601 of the web-based interface may indicate that the customer's application is declined 616 and display a link to an “Adverse Action Letter” 617. When the user selects the Adverse Action Letter link 617, an adverse action letter 619, an example of which is shown in FIG. 6D, may be automatically generated. In particular, according to one embodiment, an adverse action letter pre-populated with all customer-specific information (e.g., name and address) may be automatically created for transmitting to the customer in accordance with various regulations.

In addition, according to one embodiment, the Basic Information screen 601 may further include a selectable button 618 for exporting information extracted from the customer's credit application, credit report, and/or any supporting documents attached to the customer's deal jacket to, for example, the financing/inventory management system, a financial institution, and/or any other remote server or destination.

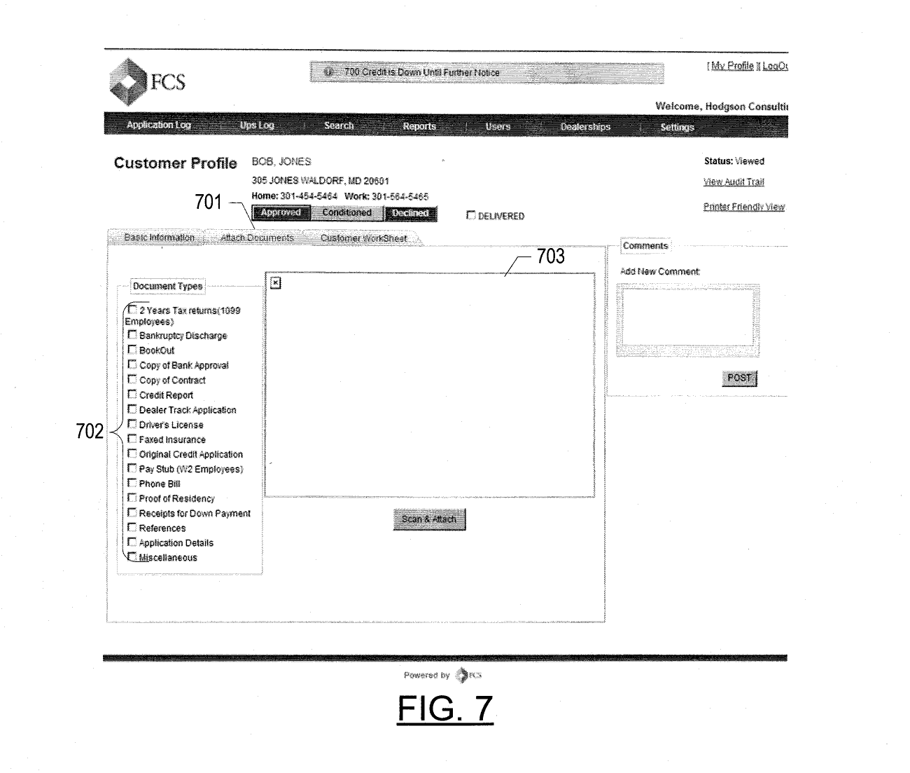

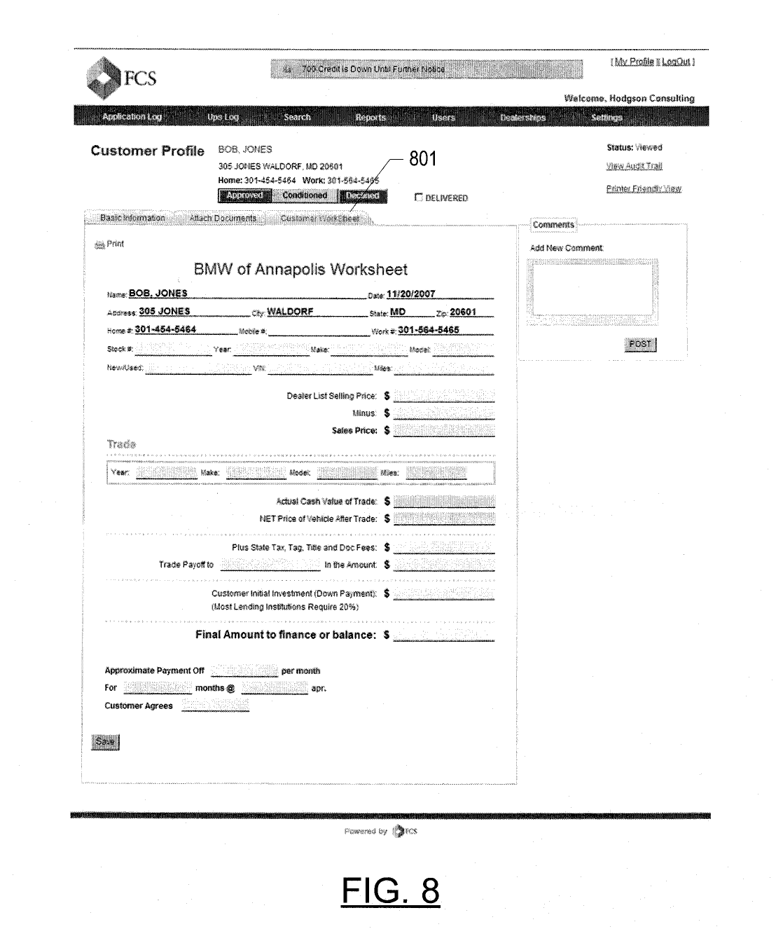

Turning now to FIG. 7, an example is provided of what may be displayed by the web-based interface in order to allow a user to attach documents to a customer's deal jacket (e.g., what may be displayed when the Attach Documents tab 701 is selected). As shown, this screen enables the user to select the type of document to be attached from a list of different document types 702, and to then scan and attach the identified document in the window provided 703. Finally, FIG. 8 provides an example of a customer worksheet that may be created and displayed in association with a customer after a deal or sale has been completed. In particular, a user (e.g., the salesperson) may manually key in the specifics of a completed deal into this worksheet in order to memorialize the deal. In one embodiment, this screen may be activated by selecting the Customer Worksheet tab 801.

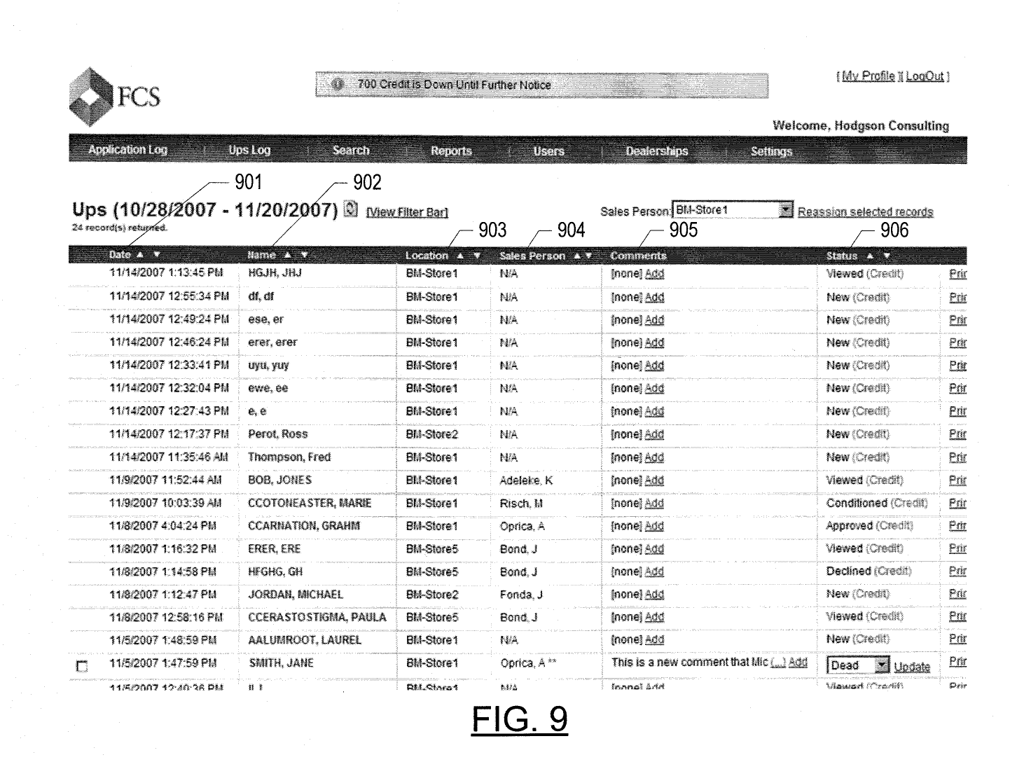

FIG. 9, which is similar to FIG. 5, provides a list of each of the Ups Logs received in association with a particular dealership or store (depending, for example, on the status of the person viewing the list of Ups Logs) over a specified period of time. As shown, the list may include the date and time on which the Ups Log was received 901, the name of the customer associated with the Ups Log 902, the location (e.g., store) receiving the Ups Log 903, the salesperson responsible for receiving the Ups Log 904, any comments 905, and the status of the corresponding customer credit application 906, if any.

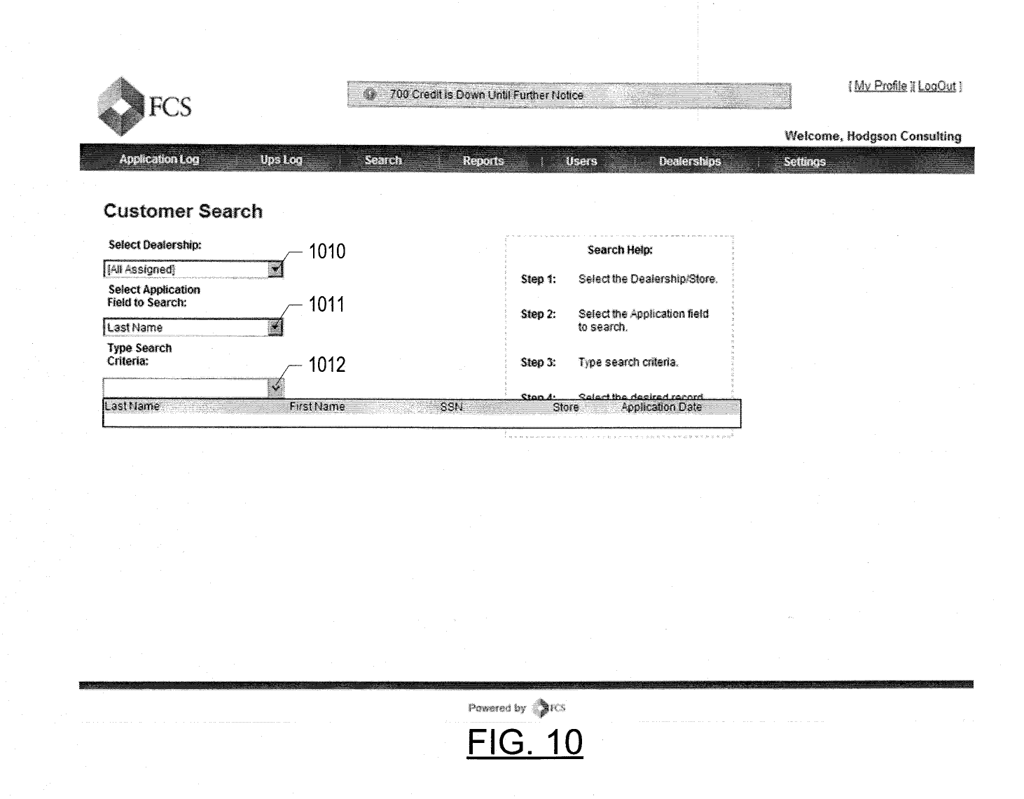

FIG. 10 illustrates a screen of the web-based interface that may be used in order to conduct a search of completed credit applications uploaded to the Finance Server 130. In one embodiment, only deal jackets associated with completed credit applications received within the past predefined period of time (e.g., 30 days) may be displayed on the Application Log of FIG. 5, while the deal jackets may be stored by the Finance Server 130 indefinitely in order to comply with various federal regulations requiring that past credit applications remain on file. The search mechanism of FIG. 10 may, therefore, be useful in searching for completed credit applications received more than 30 days ago, or prior to the predefined period of time. As shown, the user may first select the dealership for which the user would like to search for completed credit applications 1010. He or she may then select the application field within which to search 1011, and then provide the search criteria 1012 (e.g., customer last and/or first name, social security number, store, application date, etc.).

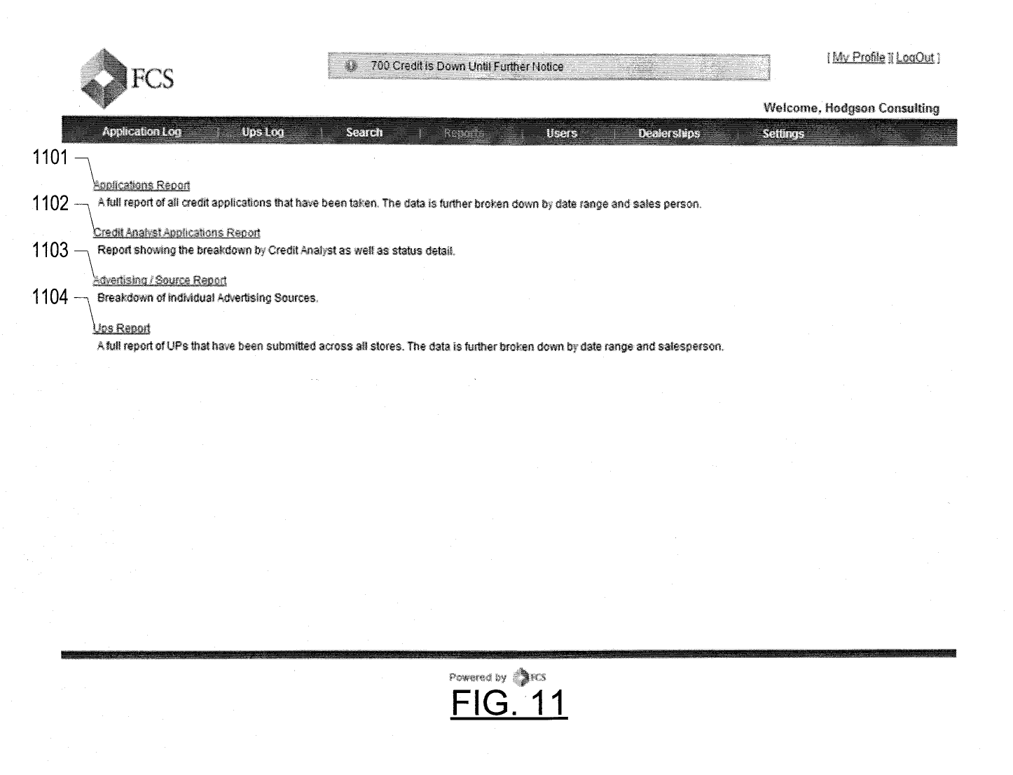

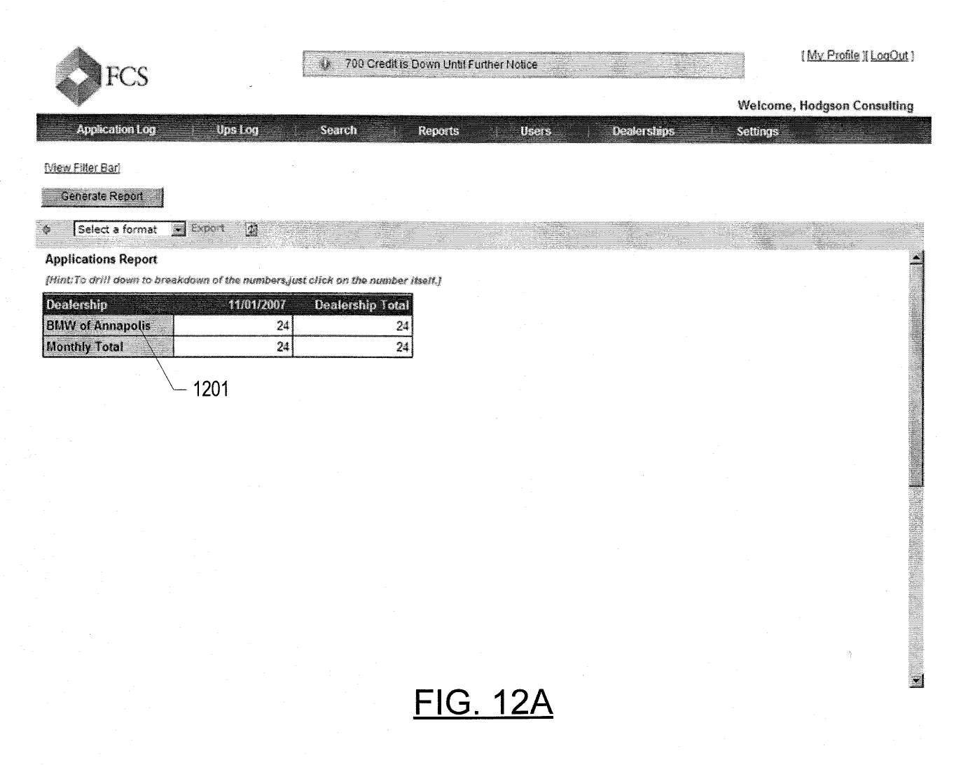

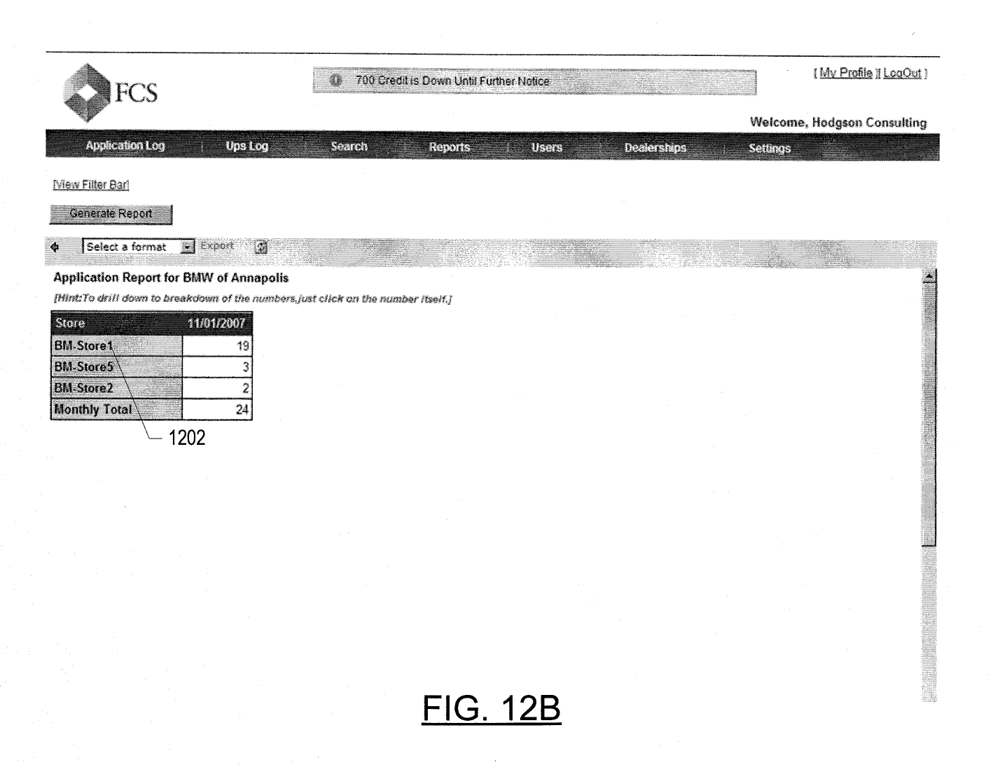

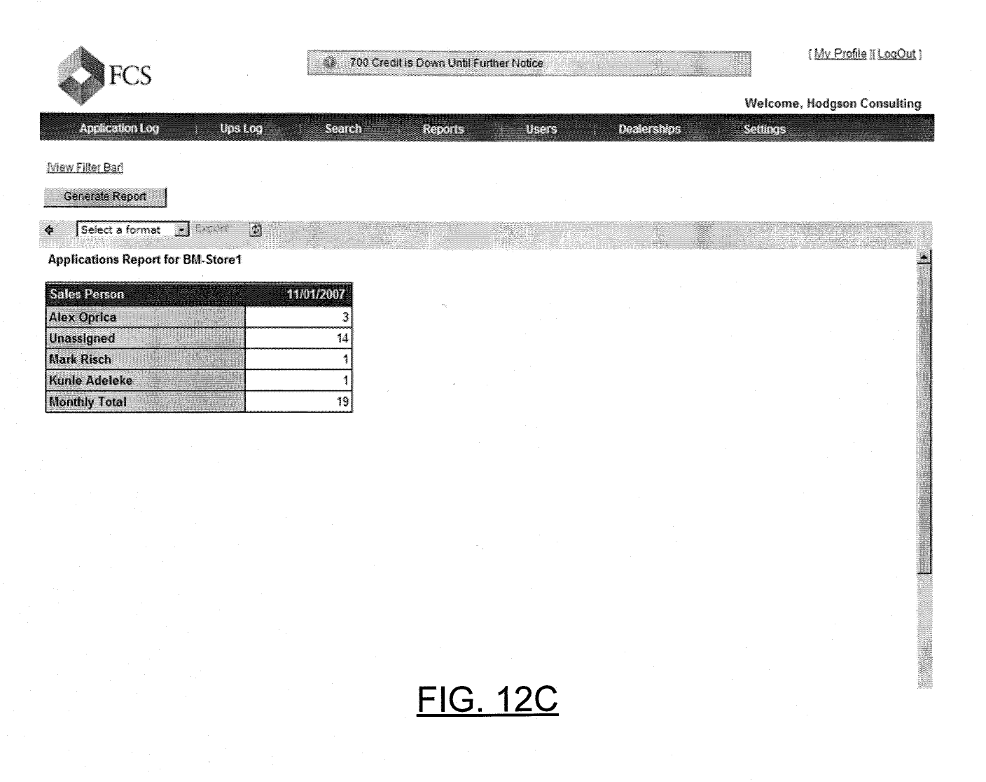

FIGS. 11 through 17E relate to reports which may be requested via the web-based interface, generated by the Finance Server 130, and then provided by the Finance Server via the web-based interface. In particular, according to one embodiment, four types of reports may be created. The first, which is referred to as the Applications Report 1101, is illustrated in FIGS. 12A-C and provides a report of all credit applications that have been taken broken down by date range, dealership, store, and ultimately salesperson. For example, FIG. 12A illustrates a report that may be generated for the total number of credit applications taken by the dealership BMW of Annapolis (e.g., 24 applications taken within the month of November of 2007, and 24 total applications taken to-date). By selecting the name of the dealership 1201, a user may break the overall number down by stores associated with the dealership, shown in FIG. 12B (e.g., 19 applications taken by BM-Store 1 in the month of November of 2007). By further selecting the name of a store 1202, the user may further break the number of applications per store down to the number of credit applications taken per salesperson, shown in FIG. 12C (e.g., 3 applications taken by Alex Oprica).

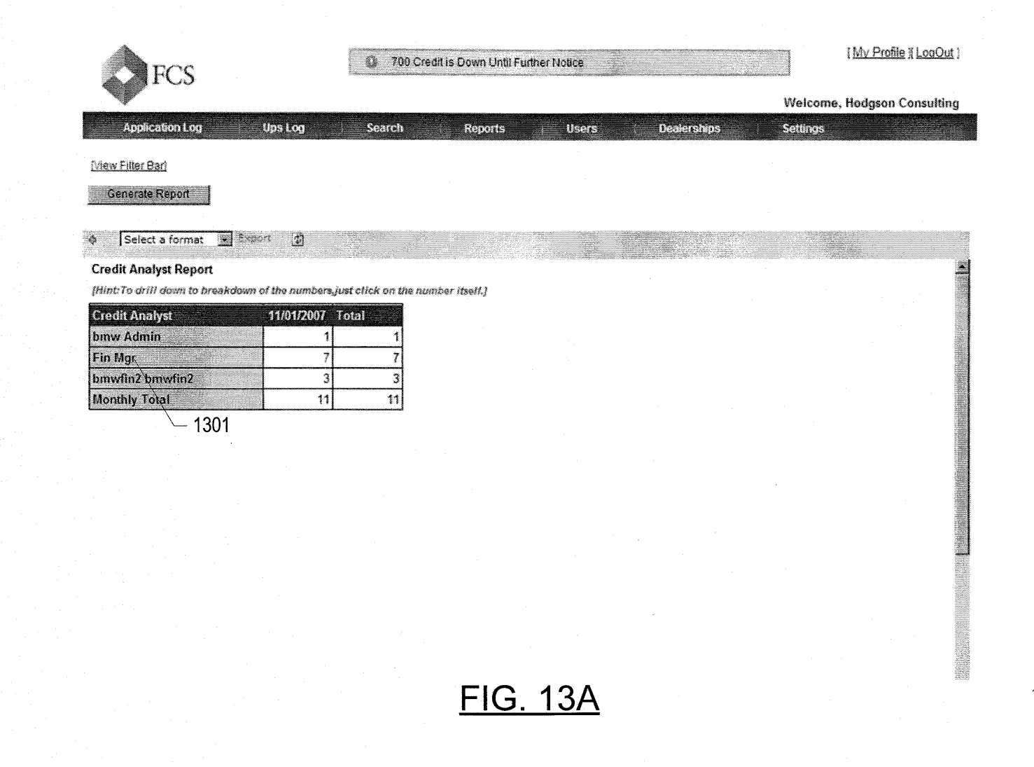

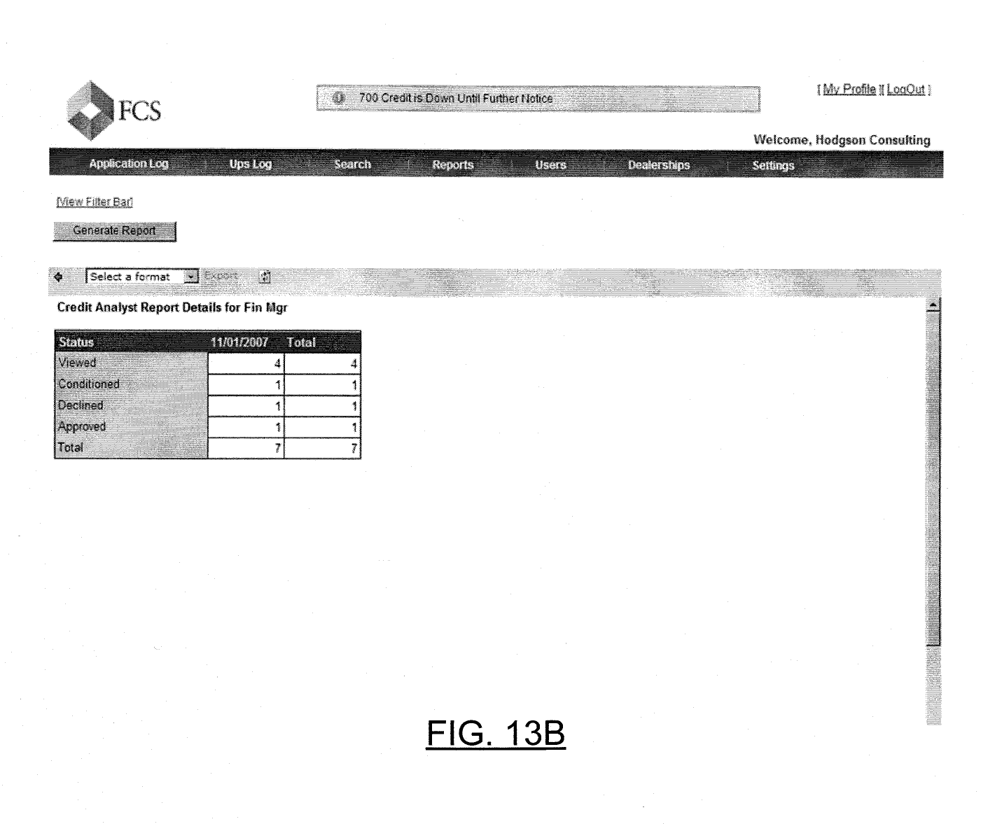

The second type of report provided by one embodiment, which is referred to as the Credit Analyst Applications Report 1102, is illustrated in FIGS. 13A-B and provides a report of the breakdown of credit applications by Credit, or financial, Analyst and status. For example, as shown in FIG. 13A, the Credit Analyst referred to as “Fin Mgr” processed seven credit applications in the month of November of 2007 and to-date. By selecting the Credit Analyst's name 1301, the user can see the breakdown by status of applications processed by the selected analyst. This is shown in FIG. 13B (e.g., Fin Mgr viewed 4 applications, conditioned 1, declined 1, and approved 1).

A third type of report provided by another embodiment of the invention is illustrated in FIG. 14 and is referred to as the Advertising/Source Report 1103. According to one embodiment of the present invention, a record may be maintained by the Finance Server 130 (e.g., in the database 135) of the various advertising initiatives undertaken by particular dealerships or stores. For example, if a dealership or store were to place an advertisement on two radio stations and in the local newspaper, a list of the two radio stations and the paper would be maintained by the Finance Server 130 in association with the dealership or store. In one embodiment, the Tablet 110 may access this advertising information in order to obtain this information and provide a customer with a list of possible advertisement/sources responsible for bringing the customer to the dealership or store. The user may select from the options when completing the credit application, and his or her selection may be uploaded to the Finance Server 130. This information may thereafter be used in order to generate this third report. In particular, as shown in FIG. 14, for each store within a dealership, a breakdown may be provided of the credit applications referencing each of the different advertisement/sources for the month and to date 1401.

In still other embodiments, information or data containing the list of possible advertisement/sources may be routinely downloaded from the Finance Server 130 or other network or non-network related processor and stored to the memory of the Tablet 110. Such data may be routinely updated to ensure that the list of possible advertisement/sources remains current.

Finally, the fourth report provided by one embodiment of the invention is an Ups Report 1104, illustrated in FIGS. 15A-C. Similar to the Applications Report, the Ups Report may provide a summary of all Ups Logs that have been submitted across all stores, as well as a breakdown of those figures by store and salesperson. For example, FIG. 15A illustrates the total number of Ups Logs received by the dealership within the month of November of 2007 and to date (e.g., 2 for the month and a total of 2 for BMW of Annapolis). By selecting the name of the dealership 1501, the user can see be breakdown of the Ups Logs by store within the dealership, shown in FIG. 15B. By then selecting the store name 1502, the user can further break the results down in order to view the number of Ups Logs received per salesperson within the store, illustrated in FIG. 15C.

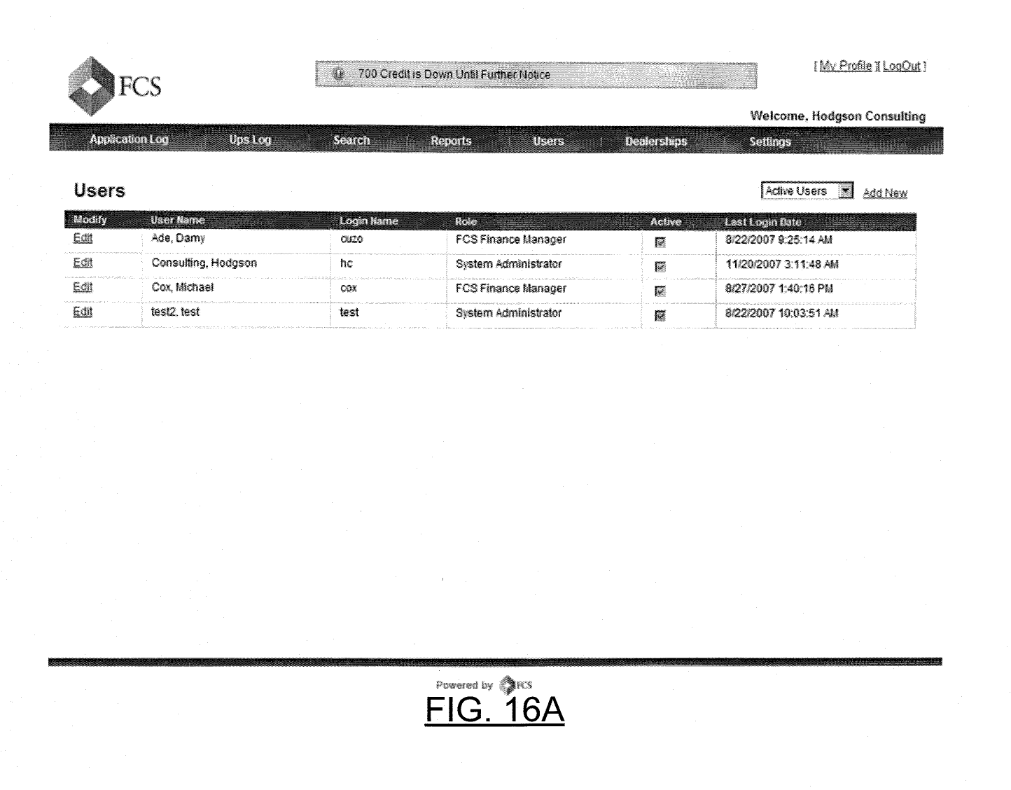

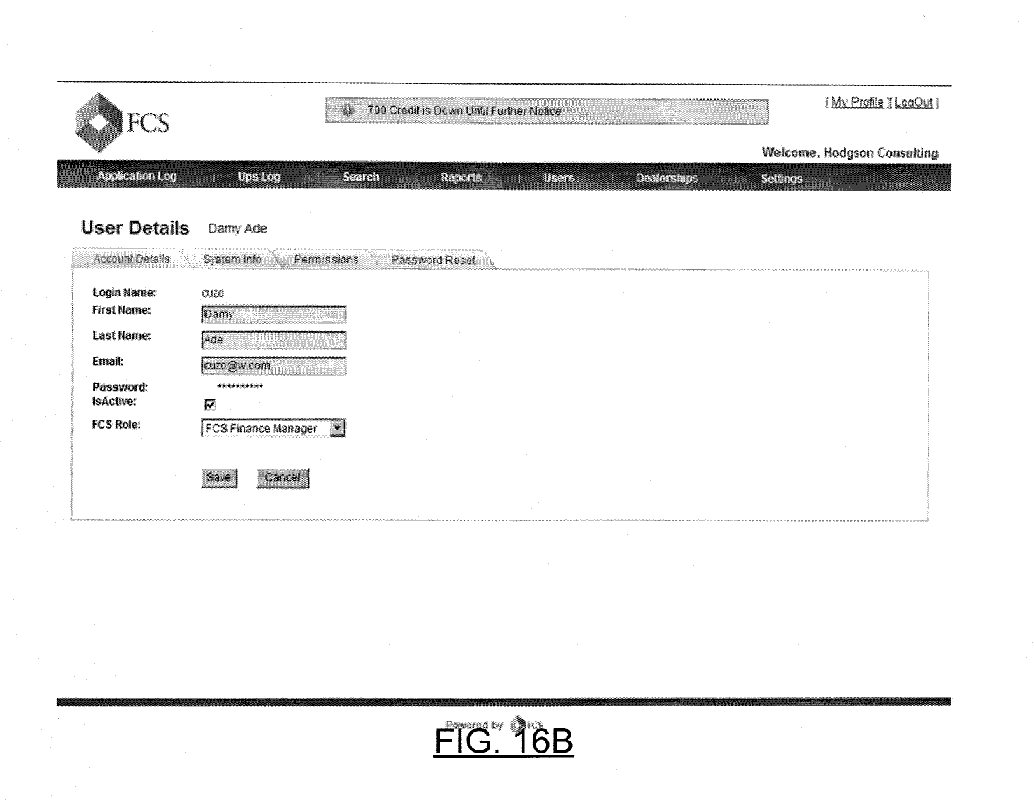

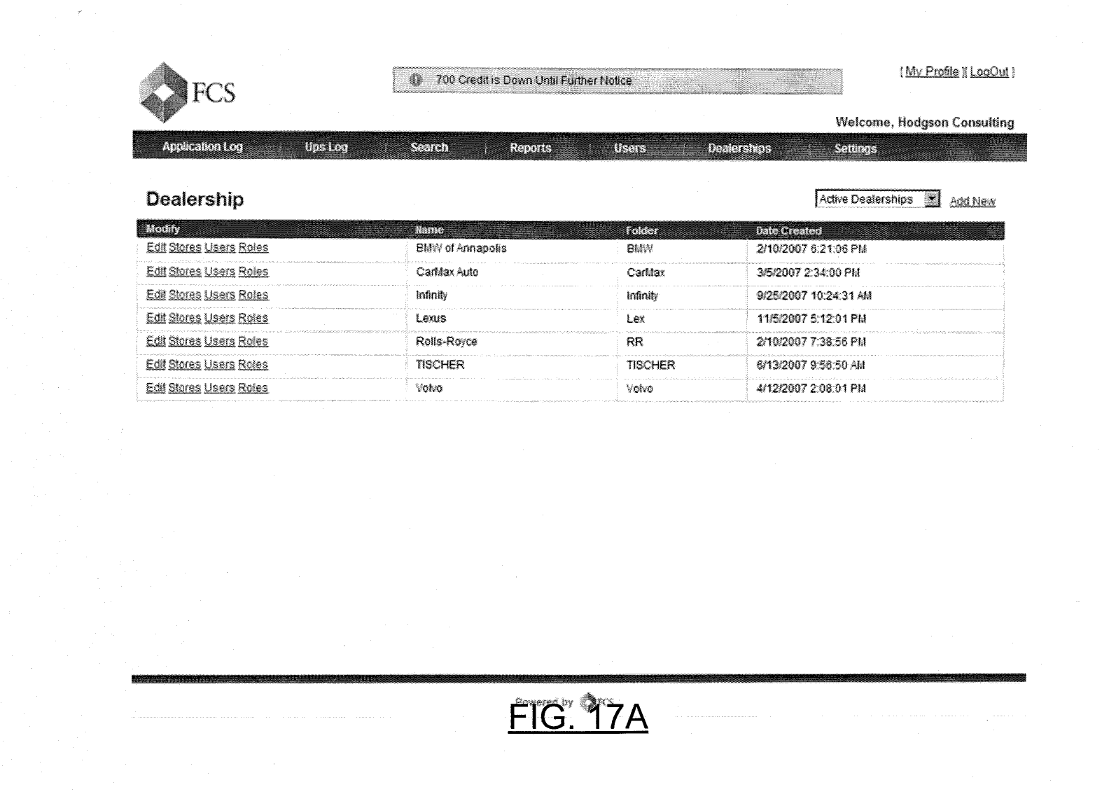

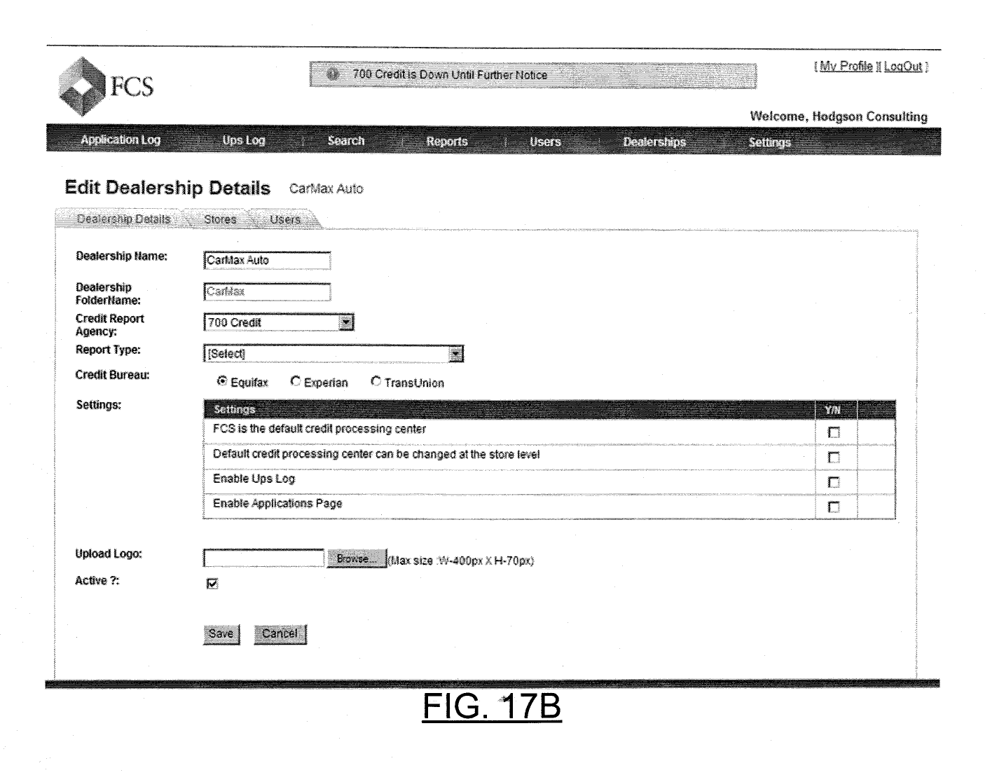

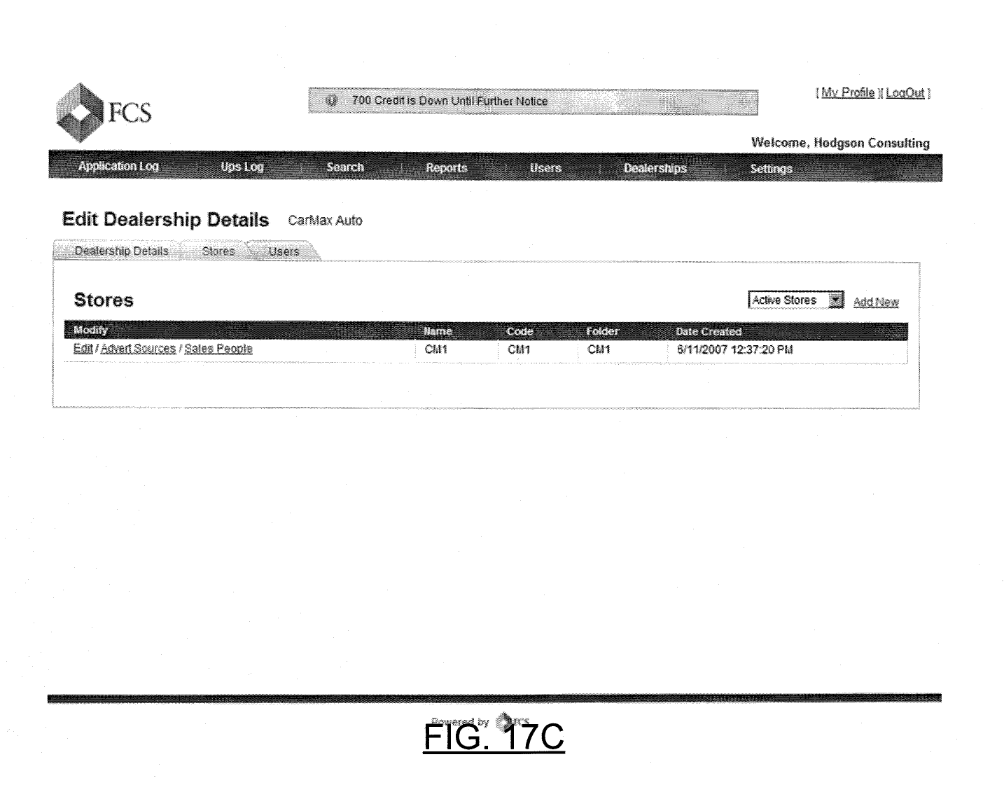

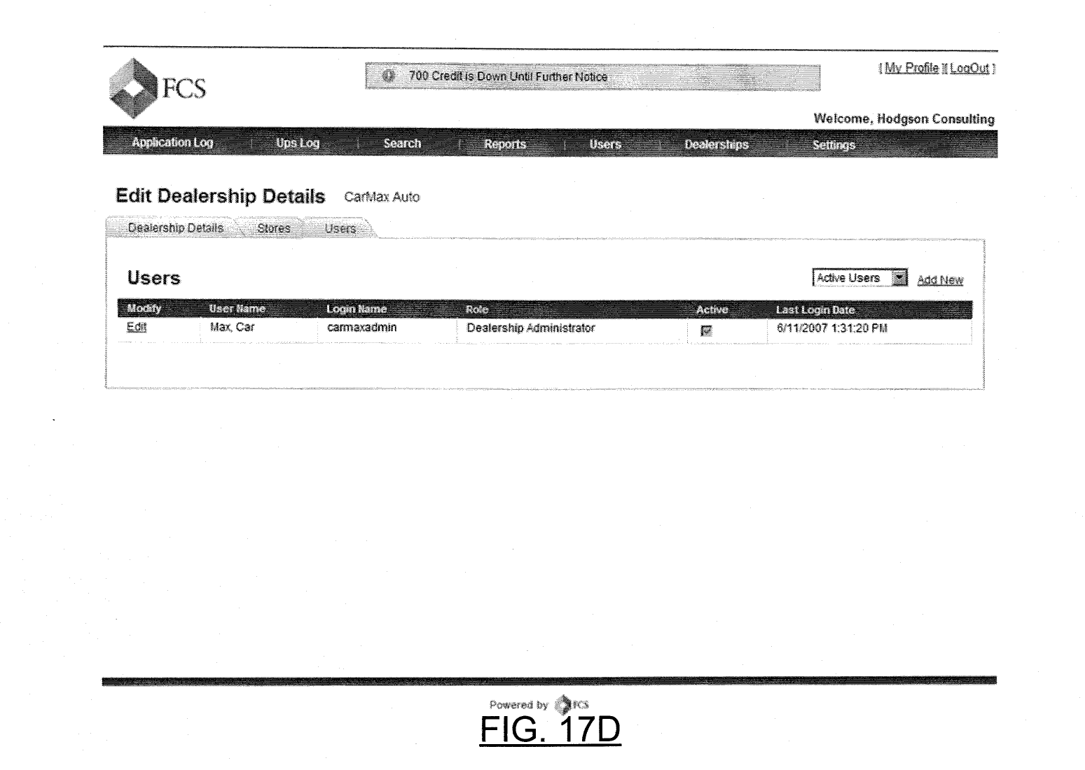

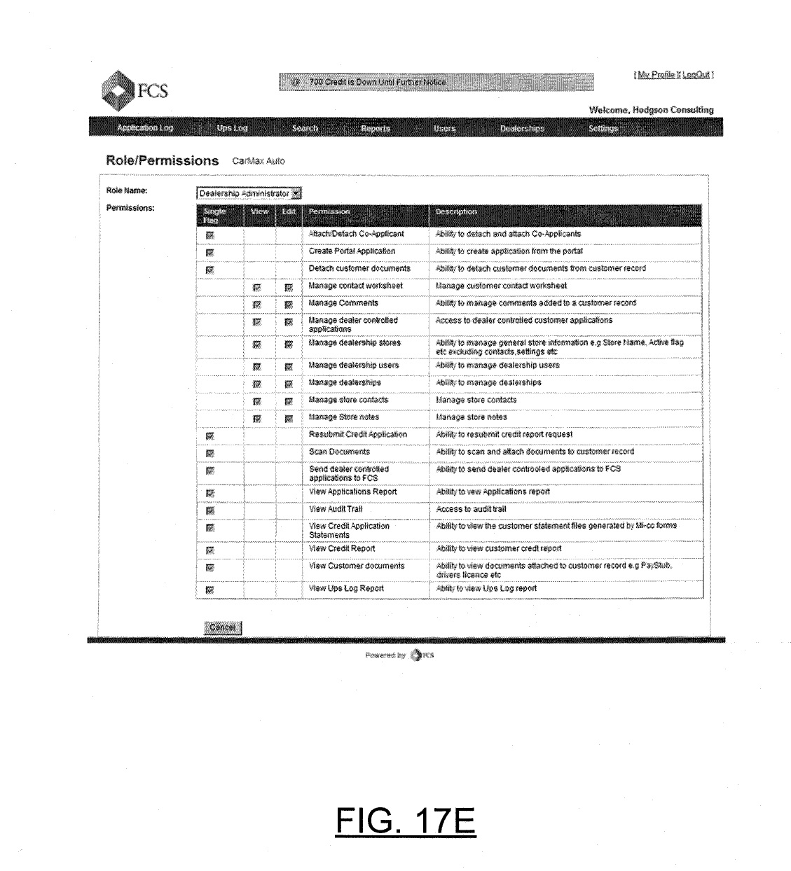

FIGS. 16A-B illustrates how a user may update profile information associated with various users of the web-based interface in order to ensure that a secure interface is provided though which private customer information can be viewed. As briefly mentioned above, the profile information associated with a user may dictate the information he or she sees when logged onto the web-based interface (e.g., a salesperson associated with one store may only see credit applications uploaded in association with his or her store, while a dealership manager may be able to view all credit applications uploaded in association with the dealership), as well as the things he or she can change once access has been granted (e.g., a financial analyst may be able to change the status of a deal jacket/credit application, while a salesperson may not). Finally, FIGS. 17A-E illustrate how certain users may be able to alter information associated with each of the dealerships and their corresponding stores in accordance with an embodiment of the present invention.

### Conclusion:

As described above and as will be appreciated by one skilled in the art, embodiments of the present invention may be configured as an apparatus or system. Accordingly, embodiments of the present invention may be comprised of various means including entirely of hardware, entirely of software, or any combination of software and hardware. Furthermore, embodiments of the present invention may take the form of a computer program product on a computer-readable storage medium having computer-readable program instructions (e.g., computer software) embodied in the storage medium. Any suitable computer-readable storage medium may be utilized including hard disks, CD-ROMs, optical storage devices, or magnetic storage devices.

Embodiments of the present invention have been described above with reference to block diagrams and flowchart illustrations of methods, apparatuses (i.e., systems) and computer program products. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus, such as processor 210 discussed above with reference to FIG. 2, to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus (e.g., processor 210 of FIG. 2) to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these embodiments of the invention pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. An apparatus comprising:
a processor configured to:
receive one or more items of information in the form of handwritten text, said items of information forming a completed credit application;
create an image of the completed credit application including the one or more items of information in the form of handwritten text;
translate the completed credit application into a digitized text file; and
transmit the image and the digitized text file, wherein once the image and the digitized text file have been transmitted, no record of the items of information remains on the apparatus.

2. The apparatus of claim 1, wherein respective items of information comprise a plurality of text characters, and wherein in order to translate the completed application into a digitized text file, the processor is further configured to use optical character recognition to translate respective text characters of the items of information into character codes recognizable by the processor.

3. The apparatus of claim 2, wherein the processor is further configured to:
create an individual extensible markup language file for respective items of information received in the form of handwritten text and translated into a plurality of character codes; and
transmit respective extensible markup language files.

4. The apparatus of claim 2, wherein the apparatus further comprises:
a touchscreen in communication with the processor, wherein in order to receive one or more items of information in the form of handwritten text, the processor is further configured to detect one or more tactile inputs to the touchscreen in the form of the plurality of text characters.

5. The apparatus of claim 1, wherein in order to transmit the image and the digitized text file, the processor is further configured to transmit the image and the digitized text file via a wireless network.

6. The apparatus of claim 5, wherein the apparatus is associated with a location, and wherein the processor is configured to transmit the image and the digitized text file via the wireless network only when the apparatus is within a communication proximity to the location.

7. The apparatus of claim 1 further comprising:
a scanner configured to capture an image of an item, wherein the processor is further configured to receive and transmit the captured image.

8. The apparatus of claim 1 further comprising:
a display, and
wherein the processor is further configured to store customization data in an electronic file and display information related to the customization data to a user via the display.

9. The apparatus of claim 8, wherein the processor is further configured to:
retrieve the customization data wirelessly from a remote server.

10. The apparatus of claim 8, wherein the customization data comprises a credit application profile.

11. The apparatus of claim 8, wherein the customization data comprises advertising information.

12. An apparatus comprising:
a processor configured to:
receive an image of a completed credit application associated with a customer, said image including one or more items of information in the form of handwritten text;
receive a digitized text file of the completed credit application;
store the image and digitized text file in an electronic file associated with the customer;
extract from the digitized text file a unique customer identifier associated with the customer; and
transmit a request for a credit report associated with the customer, said request including the extracted unique customer identifier.

13. The apparatus of claim 12, wherein the processor is further configured to:
provide access to the electronic file via a web-based interface.

14. The apparatus of claim 13, wherein the processor is further configured to:
receive, in response to the request transmitted, a credit report associated with the customer;
store the credit report in the electronic file associated with the customer; and
extract one or more items of information from the credit report for use in association with the web-based interface.

15. The apparatus of claim 13, wherein the processor is further configured to:
receive one or more scanned documents associated with the customer; and
store the scanned documents in the electronic file associated with the customer.

16. The apparatus of claim 12, wherein the processor is further configured to:
receive a personal data sheet associated with the customer, and
create the electronic file associated with the customer in response to receiving the personal data sheet.

17. The apparatus of claim 13, wherein the processor is further configured to:
receive a request, via the web-based interface, to generate a report associated with one or more completed credit applications received by the apparatus;
generate the report requested; and
provide access to the report via the web-based interface.

18. The apparatus of claim 17, wherein the report identifies a number of completed credit applications received in association with a dealership, respective stores operating in association with the dealership, and respective salespersons associated with respective stores.

19. The apparatus of claim 16, wherein the processor is further configured to:
receive a request, via the web-based interface, to generate a report comparing a number of personal data sheets received to a number of completed credit applications received;
generate the report requested; and
provide access to the report via the web-based interface.

20. The apparatus of claim 17, wherein respective completed credit applications identify one of a plurality of advertising sources associated with the completed credit application, and wherein the report identifies a number of completed credit applications received in association with respective advertising sources.

21. A system comprising:
a tablet personal computer configured to:
receive one or more items of information in the form of handwritten text, said items of information forming a completed credit application associated with a customer;
create an image of the completed credit application including the one or more items of information in the form of handwritten text;
translate the completed credit application into a digitized text file; and
transmit the image and the digitized text file, wherein once the image and the digitized text file have been transmitted, no record of the items of information remains on the tablet personal computer; and
a finance server configured to:
receive the image and the digitized text file from the tablet personal computer over a wireless network;
create an electronic file associated with the customer, said electronic file storing the image and digitized text file received; and
provide access to the electronic file via a web-based interface.

22. The system of claim 21, wherein the finance server is further configured to extract from the digitized text file received a unique customer identifier associated with the customer and to transmit a request for a credit report associated with the customer, said request including the extracted unique customer identifier, said system further comprising:
a credit report server configured to receive the request, and, in response, to transmit the credit report associated with the customer to the finance server.

23. The system of claim 22, wherein the finance server is further configured to:
receive the credit report associated with the customer;
store the credit report in the electronic file associated with the customer; and
extract one or more items of information from the credit report for use in association with the web-base interface.

24. The system of claim 23 further comprising:
an electronic device operated by a financial analyst, said electronic device configured to access the electronic file associated with the customer via the web-based interface, such that the financial analyst can review the completed credit application and credit report associated with the customer in order to assess the customer's credit status or fitness for a transaction.

25. A computer program product comprising at least one computer-readable storage medium having computer-readable program code portions stored therein, the computer-readable program code portions comprising:
a first executable portion for receiving one or more items of information in the form of handwritten text, said items of information forming a completed credit application;
a second executable portion for creating an image of the completed credit application including the one or more items of information in the form of handwritten text;
a third executable portion for translating the completed credit application into a digitized text file; and
a fourth executable portion for transmitting the image and the digitized text file, wherein once the image and the digitized text file have been transmitted, no record of the items of information remains on the apparatus.

26. The computer program product of claim 25, wherein respective items of information comprise a plurality of text characters, and wherein the third executable portion is further configured to use optical character recognition to translate respective text characters of the items of information into character codes recognizable by the processor.

27. The computer program product of claim 26, wherein the computer-readable program code portions further comprise:
a fifth executable portion for creating an individual extensible markup language file for respective items of information received in the form of handwritten text and translated into a plurality of character codes; and
a sixth executable portion for transmitting respective extensible markup language files.

28. A computer program product comprising at least one computer-readable storage medium having computer-readable program code portions stored therein, the computer-readable program code portions comprising:
a first executable portion for receiving an image of a completed credit application associated with a customer, said image including one or more items of information in the form of handwritten text;
a second executable portion for receiving a digitized text file of the completed credit application;
a third executable portion for storing the image and digitized text file in an electronic file associated with the customer;
a fourth executable portion for extracting from the digitized text file a unique customer identifier associated with the customer; and
a fifth executable portion for transmitting a request for a credit report associated with the customer, said request including the extracted unique customer identifier.

29. The computer program product of claim 28, wherein the computer-readable program code portions further comprise:
a sixth executable portion for providing access to the electronic file via a web-based interface.

30. The computer program product of claim 29, wherein the computer-readable program code portions further comprise:
a seventh executable portion for receiving, in response to the request transmitted, a credit report associated with the customer;
an eighth executable portion for storing the credit report in the electronic file associated with the customer; and
a ninth executable portion for extracting one or more items of information from the credit report for use in association with the web-base interface.

31. The computer program product of claim 29, wherein the computer-readable program code portions further comprise:
a seventh executable portion for receiving a request, via the web-based interface, to generate a report associated with one or more completed credit applications received by the apparatus;
an eighth executable portion for generating the report requested; and
a ninth executable portion for providing access to the report via the web-based interface.

32. A system comprising:
a computer configured to:
receive one or more items of information forming a completed credit application associated with a customer;
receive an image providing authentication that the completed credit application is associated with the customer;
translate the one or more items of information into a digitized text file; and
transmit the image and the digitized text file, wherein once the image and the digitized text file have been transmitted, no record of the items of information remains on the computer; and
a finance server configured to:
receive the image and the digitized text file from the computer over a wireless network;
create an electronic file associated with the customer, said electronic file storing the image and digitized text file received; and
provide access to the electronic file via a web-based interface.

33. The system of claim 32, wherein the image providing authentication is an image of handwriting text written by the customer.

34. The system of claim 32, wherein the image providing authentication is an image of a fingerprint of the customer.

35. The system of claim 32, wherein the image providing authentication is an image of a retinal scan of the customer.

36. The system of claim 32, wherein the one or more items of information comprise handwritten text characters, and wherein in order to translate the one or more items of information into the digitized text file, the computer is further configured to use optical character recognition to translate respective handwritten text characters of the items of information into character codes recognizable by the computer.

37. The system of claim 36, wherein the computer is further configured to:
create an individual extensible markup language file for respective items of information received as handwritten text characters and translated into character codes; and
transmit respective extensible markup language files to the finance server.

38. The system of claim 33, wherein the computer comprises a touchscreen, and wherein the computer is further configured to detect one or more tactile inputs to the touchscreen to receive the image of handwriting text written by the customer.

39. The system of claim 32, wherein the computer is associated with a location, and wherein the computer is configured to transmit the image and the digitized text file via a wireless network only when the computer is within a communication proximity to the location.

40. The system of claim 32, wherein the computer is further configured to:
communicate with a scanner configured to capture an image of an item, and wherein the computer is further configured to receive and transmit the captured image to the finance server.

41. The system of claim 32, wherein the computer is further configured to:
store customization data; and
display information related to the customization data to a user.

42. The system of claim 41, wherein the computer is further configured to:
retrieve the customization data wirelessly from a remote server.

43. The system of claim 41, wherein the customization data comprises a credit application profile.

44. The system of claim 41, wherein the customization data comprises advertising information.

45. The system of claim 41, wherein the finance server is further configured to extract from the digitized text file received a unique customer identifier associated with the customer and to transmit a request for a credit report associated with the customer, said request including the extracted unique customer identifier, said system further comprising:
a credit report server configured to receive the request, and, in response, to transmit the credit report associated with the customer to the finance server.

46. The system of claim 45, wherein the finance server is further configured to:
receive the credit report associated with the customer;
store the credit report in the electronic file associated with the customer; and
extract one or more items of information from the credit report for use in association with the web-base interface.

47. The system of claim 45, further comprising:
a financial institution server in electronic communication with the finance server in order to gain access to credit information stored in the electronic file associated with the customer, said financial institution server configured to:
compare the credit information to a plurality of financial products; and
select one or more acceptable products from the plurality based at least in part on the comparison.

48. The system of claim 45, further comprising:
a financing/inventory management server in electronic communication with the finance server in order to gain access to credit information stored in the electronic file associated with the customer, said financial institution server configured to:
compare the credit information to a plurality of financial products; and
select one or more acceptable products from the plurality based at least in part on the comparison.

49. The system of claim 48, wherein the financing/inventory management server is further configured to generate, based at least in part on the credit information accessed, one or more closing documents associated with a transaction completed in association with the customer.

50. The system of claim 48, wherein the financing/inventory management server is further configured to generate a recommendation of an item to sell to the customer based at least in part on the credit information accessed and an estimated profitability associated with such a sale.

51. The system of claim 48, wherein the financing/inventory management server is further configured to generate one or more reports based at least in part on credit information accessed in association with a plurality of customers.

52. The system of claim 32, wherein the finance server is further configured to:
receive a personal data sheet associated with the customer; and
create the electronic file associated with the customer in response to receiving the personal data sheet.

53. The system of claim 52, wherein the finance server is further configured to:
receive a request, via the web-based interface, to generate a report comparing a number of personal data sheets received to a number of completed credit applications received;
generate the report requested; and
provide access to the report via the web-based interface.

54. The system of claim 32, wherein the completed credit application received identifies one of a plurality of advertising sources associated with the completed credit application, and wherein, the finance server is further configured to:
receive a request, via the web-based interface, to generate a report identifying a number of completed credit applications received in association with respective advertising sources;
generate the requested report; and
provide access to the report via the web-based interface.
